(19) United States
(12) Patent Application Publication
(10) Pub. No.: US 2013/0101033 A1
(43) Pub. Date: Apr. 25, 2013

(54) CODING NON-SYMMETRIC DISTRIBUTIONS OF DATA

(71) Applicant: QUALCOMM INCORPORATED, San Diego, CA (US)

(72) Inventors: Rajan Laxman Joshi, San Diego, CA (US); Joel Sole Rojals, La Jolla, CA (US); Marta Karczewicz, San Diego, CA (US)

(73) Assignee: QUALCOMM INCORPORATED, San Diego, CA (US)

(21) Appl. No.: 13/649,836

(22) Filed: Oct. 11, 2012

Related U.S. Application Data
(60) Provisional application No. 61/583,567, filed on Jan. 5, 2012.
(60) Provisional application No. 61/556,774, filed on Nov. 7, 2011.
(60) Provisional application No. 61/556,770, filed on Nov. 7, 2011.
(60) Provisional application No. 61/547,650, filed on Oct. 14, 2011.
(60) Provisional application No. 61/547,647, filed on Oct. 14, 2011.

(51) Int. Cl. H04N 7/26; H04N 7/50

(52) U.S. Cl. 375/240.12; 375/240.01; 375/E07.026; 375/E07.211

(57) ABSTRACT

This disclosure describes techniques for coding non-symmetric distributions of data and techniques for quantization matrix compression. The techniques for coding non-symmetric distributions of data may use a mapping that is configured to bias either positive data values or negative data values of a signed integer source towards shorter codewords of a variable length code that codes non-negative integers. This may allow signed integer data sources that have non-symmetric distributions of data to be coded in a more efficient manner. The quantization matrix compression techniques of this disclosure may use a predictor that is configured to generate prediction residuals for a quantization matrix that are skewed in favor of positive values. This may allow entropy coding techniques that favor data distributions which are skewed toward positive data values (e.g., the techniques for coding non-symmetric distributions described above) to be used to increase the coding efficiency of the quantization matrix.

### CROSS-REFERENCE TO RELATED APPLICATIONS

This application claims the benefit of U.S. Provisional Application No. 61/583,567, filed Jan. 5, 2012, U.S. Provisional Application No. 61/556,774, filed Nov. 7, 2011, U.S. Provisional Application No. 61/556,770, filed Nov. 7, 2011, U.S. Provisional Application No. 61/547,650, filed Oct. 14, 2011, and U.S. Provisional Application No. 61/547,647, filed Oct. 14, 2011, the entire contents of each of which is incorporated herein by reference.

### TECHNICAL FIELD

This disclosure relates to data coding and, more particularly, to techniques for coding video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video frame or slice may be partitioned into blocks. Each block can be further partitioned. Blocks in an intra-coded (I) frame or slice are encoded using spatial prediction with respect to reference samples in neighboring blocks in the same frame or slice. Blocks in an inter-coded (P or B) frame or slice may use spatial prediction with respect to reference samples in neighboring blocks in the same frame or slice or temporal prediction with respect to reference samples in other reference frames. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

This disclosure describes techniques for coding non-symmetric distributions of data and techniques for quantization matrix compression. The techniques for coding non-symmetric distributions of data may use a mapping that is configured to bias either positive data values or negative data values of a signed integer source towards shorter codewords of a variable length code that codes non-negative integers. This may allow signed integer data sources that have probability distributions which are skewed in favor of either positive or negative values to be coded in a more efficient manner.

The quantization matrix compression techniques of this disclosure may use predictive coding techniques that produce prediction residuals for a quantization matrix that are skewed in favor of positive values. This may allow entropy coding techniques that favor data distributions which are skewed toward positive data values (e.g., the techniques for coding non-symmetric distributions described in this disclosure) to be used to increase the coding efficiency of the quantization matrix.

In one example, the disclosure describes a method for coding video data that includes converting between a set of source symbols selected from a source symbol alphabet and a set of mapped symbols selected from a mapped symbol alphabet based on a mapping between symbol values in the source symbol alphabet and symbol values in the mapped symbol alphabet. The symbol values in the source symbol alphabet include positive symbol values and negative symbol values. Each of the symbol values in the mapped symbol alphabet is a non-negative symbol value. The mapping biases lower symbol values of the mapped symbol alphabet toward positive symbol values of the source symbol alphabet or negative symbol values of the source symbol alphabet. The method further includes coding the mapped symbols using variable length codewords.

In another example, the disclosure describes a device for coding video data that includes one or more processors configured to convert between a set of source symbols selected from a source symbol alphabet and a set of mapped symbols selected from a mapped symbol alphabet based on a mapping between symbol values in the source symbol alphabet and symbol values in the mapped symbol alphabet, and to code the mapped symbols using variable length codewords. The symbol values in the source symbol alphabet include positive symbol values and negative symbol values. Each of the symbol values in the mapped symbol alphabet is a non-negative symbol value. The mapping biases lower symbol values of the mapped symbol alphabet toward positive symbol values of the source symbol alphabet or negative symbol values of the source symbol alphabet.

In another example, the disclosure describes an apparatus for coding video data that includes means for converting between a set of source symbols selected from a source symbol alphabet and a set of mapped symbols selected from a mapped symbol alphabet based on a mapping between symbol values in the source symbol alphabet and symbol values in the mapped symbol alphabet. The symbol values in the source symbol alphabet include positive symbol values and negative symbol values. Each of the symbol values in the mapped symbol alphabet is a non-negative symbol value. The mapping biases lower symbol values of the mapped symbol alphabet toward positive symbol values of the source symbol alphabet or negative symbol values of the source symbol alphabet. The apparatus further includes means for coding the mapped symbols using variable length codewords.

In another example, the disclosure describes a computer-readable storage medium storing instructions that, when executed, cause one or more processors to convert between a set of source symbols selected from a source symbol alphabet and a set of mapped symbols selected from a mapped symbol alphabet based on a mapping between symbol values in the source symbol alphabet and symbol values in the mapped symbol alphabet, and code the mapped symbols using variable length codewords. The symbol values in the source symbol alphabet include positive symbol values and negative symbol values. Each of the symbol values in the mapped symbol alphabet is a non-negative symbol value. The mapping biases lower symbol values of the mapped symbol alphabet toward positive symbol values of the source symbol alphabet or negative symbol values of the source symbol alphabet.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system according to this disclosure.

FIG. 2 is a block diagram illustrating an example video encoder according to this disclosure.

FIG. 3 is a block diagram illustrating an example entropy encoding unit according to this disclosure.

FIG. 4 is a block diagram illustrating another example entropy encoding unit according to this disclosure.

FIG. 5 is a conceptual diagram illustrating a raster scan order for a quantization matrix according to this disclosure.

FIG. 6 is a conceptual diagram illustrating an example quantization matrix according to this disclosure.

FIG. 7 is a block diagram illustrating an example video decoder according to this disclosure.

FIG. 8 is a block diagram illustrating an example entropy decoding unit according to this disclosure.

FIG. 9 is a block diagram illustrating another example entropy decoding unit according to this disclosure.

FIG. 10 is a flow diagram illustrating an example technique for coding non-symmetric distributions of data according to this disclosure.

FIG. 11 is a flow diagram illustrating an example technique for encoding non-symmetric distributions of data according to this disclosure.

FIG. 12 is a flow diagram illustrating an example technique for decoding non-symmetric distributions of data according to this disclosure.

FIG. 13 is a flow diagram illustrating an example technique for coding a quantization matrix according to this disclosure.

FIG. 14 is a flow diagram illustrating an example technique for encoding a quantization matrix according to this disclosure.

FIG. 15 is a flow diagram illustrating an example technique for decoding a quantization matrix according to this disclosure.

### DETAILED DESCRIPTION

Some types of variable length codes, such as variable length codes in the Golomb family, are designed to encode sets of non-negative integers using variable length codewords. Typically, these codes are designed such that shorter length codewords are assigned to smaller non-negative integers. When coding a signed integer source using such a code, traditional coding systems may map the signed integer source to a set of non-negative integers prior to applying the variable length code. A mapping that is commonly used in such systems involves alternating between assigning positive source symbol values and negative source symbol values to a set of non-negative integers as the non-negative integers increase in value. More specifically, the mapping may assign positive and negative source values of the same magnitude to adjacent non-negative integers in a mapped symbol alphabet such that lower-magnitude source symbols are assigned to lower-valued non-negative integers in the mapped symbol alphabet. Such a mapping may distribute shorter length codewords between positive and negative source values in a substantially even or balanced manner. Therefore, such a mapping may be inefficient in cases where non-symmetric distributions of data are to be coded (e.g., data that is heavily skewed towards either positive or negative values).

This disclosure describes techniques for coding non-symmetric distributions of data. The techniques for coding non-symmetric distributions of data may use a mapping that is configured to bias either positive data values or negative data values of a signed integer source towards shorter codewords of a variable length code that codes non-negative integers. This may allow signed integer data sources that have probability distributions which are skewed in favor of either positive or negative values to be coded in a more efficient manner.

The techniques for coding non-symmetric distributions of data may be used to code any type of data. As one particular example, the techniques of this disclosure may be used to code video data, such as, e.g., residual transform coefficient values, motion vector data, quantization matrices, quantization matrix prediction residuals, syntax elements, or other video data. The techniques for coding non-symmetric distributions of data may use variable length codes such as Golomb, Golomb-Rice or exponential Golomb codes, or truncated versions of such codes.

The mapping used for coding non-symmetric distributions of data may be a mapping between a source symbol alphabet and a mapped symbol alphabet. The mapped symbol alphabet may correspond to the domain (i.e., the range of possible input values) of a variable length code, while the source symbol alphabet may contain one or more values that are outside of the domain of the variable length code. For example, the mapped symbol alphabet may contain only non-negative symbol values, and the source symbol alphabet may contain positive symbol values and negative symbol values. The variable length code may assign shorter codewords to lower-valued symbols in the mapped symbol alphabet.

In some examples, the mapping may bias lower symbol values of the mapped symbol alphabet toward positive symbol values of the source symbol alphabet. In such examples, the mapping may be biased in the sense that more positive source symbol values are assigned to lower values of the mapped symbol alphabet than non-positive source symbol values. For example, for a set of L lowest-valued symbol values in the mapped symbol alphabet, the mapping may assign more positive symbol values in the source symbol alphabet than non-positive symbol values in the source symbol alphabet to the set of L lowest-valued symbol values for at least one L where L is an integer greater than or equal to two. As another example, for a set of K lowest-valued symbol values in the mapped symbol alphabet, the number of positive source symbols that are assigned by the mapping to the set of K lowest-valued symbol values in the mapped symbol alphabet may be greater than K/2 for at least one K where K is an integer greater than or equal to two. It should be noted that the expression “K/2” represents normal division where the fractional portion of the quotient is retained as opposed to integer division where the fractional portion of the quotient is discarded. For example, if K=5, then K/2=2.5.

In additional examples, for a set of L lowest-valued symbol values in the mapped symbol alphabet, the number of positive symbol values in the source symbol alphabet assigned by the mapping to L lowest-valued symbol values in the mapped symbol alphabet may be greater than the number of negative symbol values in the source symbol alphabet assigned by the mapping to L lowest-valued symbol values by at least two for at least one L where L is an integer greater than or equal to two. In further examples, the mapping may assign positive symbol values in the source symbol alphabet to at least two consecutive symbol values in the mapped symbol alphabet.

In additional examples, for a set of N lowest-valued symbols in the mapped symbol alphabet, the mapping may assign a respective one of a plurality of non-negative symbol values in the source symbol alphabet to each of the symbol values in the set of N lowest-valued symbol values, where N is an integer greater than or equal to three. In some cases, N may be a programmable and/or configurable value.

In additional examples, for at least a subset of the symbol values in the mapped symbol alphabet, the mapping may assign a respective one of the negative symbol values in the source symbol alphabet to every Mth symbol value in the subset of the symbol values in the mapped symbol alphabet, where M is an integer greater than or equal to three. In such examples, the mapping may also assign respective ones of the positive symbol values in the source symbol alphabet to (M−1) symbol values in the mapped symbol alphabet that are between every Mth symbol value in the subset of the symbol values. In some cases, M may be a programmable and/or configurable value.

The mapping may utilize one or both of an offset and a scaling factor to control the mapping of source symbols to mapped symbols for the determination of variable length codes. The offset may specify and/or control a number of lowest-valued symbols in the mapped symbol alphabet that are assigned by the mapping to non-negative symbol values in the source symbol alphabet. The scaling factor may specify and/or control a distance between each of a plurality of symbol values in the mapped symbol alphabet that are assigned by the mapping to negative symbol values in the source symbol alphabet.

In some examples, the offset may specify that the mapping is to assign at least three lowest-valued symbols in the mapped symbol alphabet to non-negative symbol values in the source symbol alphabet. In further examples, a scaling factor may specify that a distance of greater than or equal to three symbol values between each of a plurality of symbol values in the mapped symbol alphabet that are assigned by the mapping to negative symbol values in the source symbol alphabet.

The example mappings described above relate to mappings that bias lower symbol values of the mapped symbol alphabet toward positive symbol values of the source symbol alphabet. In additional examples, similar mappings may be used that bias lower symbol values of the mapped symbol alphabet toward negative symbol values of the source symbol alphabet. For example, for a set of L lowest-valued symbol values in the mapped symbol alphabet, the mapping may assign more negative symbol values in the source symbol alphabet than non-negative symbol values in the source symbol alphabet to the set of L lowest-valued symbol values for at least one L where L is an integer greater than or equal to two. As another example, for a set of K lowest-valued symbol values in the mapped symbol alphabet, the number of negative source symbols that are assigned by the mapping to the set of K lowest-valued symbol values in the mapped symbol alphabet may be greater than K/2 for at least one K where K is an integer greater than or equal to two. Other example mappings that bias lower valued mapped symbol values toward negative source symbol values may be defined and/or constructed by reversing the sign or polarity of the source symbols for the mappings described above that are configured to bias lower valued mapped symbols toward positive source symbol values.

In some examples, the mappings of this disclosure may be one-to-one such that, when the mapping is used by an encoder, a decoder may use an inverse mapping to reproduce the source symbols. As described above, the mapping can be used with Golomb, Golomb-Rice or exponential Golomb codes, or truncated versions of such codes. Similarly, the mapping techniques of this disclosure may be used in conjunction with other codes for non-negative integers that use longer codewords for higher magnitudes. The mapping techniques of this disclosure may be used to improve coding efficiency of source symbols, particularly in the case where the source symbols have probabilities that are significantly skewed towards positive values. If the source symbols (X), however, are significantly skewed towards negative values, for example, the mapping techniques of this disclosure may be applied to additive inverses of the source symbols (i.e., −X).

This disclosure also describes techniques for quantization matrix compression. In video coding, quantization matrices may be used to weight different frequency coefficients of a transformed video block according to the degree at which such frequency coefficients are perceived by the human visual system. For example, a quantization matrix may be designed to provide more resolution to more perceivable frequency components (e.g., typically lower frequency components) and less resolution for less perceivable frequency components (e.g., typically higher frequency components). The quantization matrix that is used to code a particular video block may change at a sequence level or even at a picture level. In such cases, a video encoder may need to code the quantization matrices and include them in the bit-stream.

To decrease the number of bits required to code the quantization matrices, an encoder designed according to the techniques of this disclosure may, in some examples, use predictive techniques to produce prediction residuals for a quantization matrix that are skewed in favor of positive values. This may allow entropy coding techniques that favor data distributions which are skewed toward positive data values to be used to increase the coding efficiency of the quantization matrix. For example, the techniques described in this disclosure for coding non-symmetric data distributions may be used to increase coding efficiency of a quantization matrix that is predicted according to the quantization matrix predictive coding techniques of this disclosure. For instance, mappings that are configured to bias positive data values towards shorter codewords of a variable length code, as described in this disclosure, may be used to increase coding efficiency of such quantization matrices.

The predictive coding techniques used for encoding and decoding quantization matrix values according to this disclosure may define a predictor for a value to be coded based on values in the quantization matrix that have horizontal and vertical frequency components that are less than or equal to the horizontal and vertical frequency components of the value to be coded. For example, the predictive coding techniques may define a predictor for encoding and decoding a value at a particular scan position in a quantization matrix as being equal to the maximum of a value immediately to the left of the current scan position in the quantization matrix and a value immediately above the current scan position in the quantization matrix.

Quantization matrices are typically designed such that the coefficients generally, but not necessarily without exception, increase both in the row (left to right) and column (top to bottom) directions. For example, as a block of transform coefficients extends from DC in the upper left (0, 0) corner to highest frequency coefficients toward the lower right (n, n) corner, the corresponding values in the quantization matrix generally increase. The reason for such a design is that the contrast sensitivity function (CSF) of the human visual system (HVS) decreases with increasing frequency, both in horizontal and vertical directions. Therefore, by selecting predictors for encoding values in a quantization matrix based on values in the quantization matrix that have horizontal and vertical frequency components that are less than or equal to those of the values to be encoded, the quantization matrix compression techniques of this disclosure may increase the likelihood of the resulting prediction residuals being positive, thereby generating a set of prediction residuals that are skewed towards positive values.

In some examples, the predictor for a value to be coded in a quantization matrix may be generated based on values in the quantization matrix that have positions in the quantization matrix which are adjacent to the position corresponding to the value to be coded in the quantization matrix. For example, as described above, the predictor for coding a particular value at a particular scan position in the quantization matrix may be equal to the maximum of a value immediately to the left of the current scan position and a value immediately above the current scan position in the quantization matrix. Because the values in a quantization matrix generally increase in both the vertical and horizontal directions, using adjacent values that are immediately to the left of and immediately above of the current scan position in the quantization matrix for predicting a value at the current scan position in the quantization matrix, as described in the previous example, not only increases the likelihood of the resulting prediction residuals being positive, but also increases the likelihood of the resulting prediction residuals being relatively close to zero in comparison to using quantization matrix values that are further away from the value to be coded. In this manner, the techniques of this disclosure may be used, in some examples, to generate a set of prediction residuals that are skewed towards positive values while maintaining a prediction residual that is relatively close to zero.

In further examples, a scanning unit for scanning the quantization matrix may scan the quantization matrix coefficients in a raster scan order. The raster scan order may allow the decoding of the quantization matrix values to take place in the same order as the order in which the encoded quantization prediction residuals were scanned by the video encoder, thereby reducing the complexity of the video decoder. In addition, the raster scan order may allow a pipelined implementation of the decoding and inverse scanning operations to be used for decoding the quantization matrix, thereby increasing the coding performance of the system.

Video coding will be described for purposes of illustration. The coding techniques described in this disclosure also may be applicable to other types of data coding. Digital video devices implement video compression techniques to encode and decode digital video information more efficiently. Video compression may apply spatial (intra-frame) prediction and/or temporal (inter-frame) prediction techniques to reduce or remove redundancy inherent in video sequences.

A typical video encoder partitions each frame of the original video sequence into contiguous rectangular regions called “blocks” or “coding units.” These blocks are encoded in “intra mode” (I-mode), or in “inter mode” (P-mode or B-mode).

For P- or B-mode, the encoder first searches for a block similar to the one being encoded in a “reference frame,” denoted by F_{ref}. Searches are generally restricted to being no more than a certain spatial displacement from the block to be encoded. When the best match, i.e., predictive block or “prediction,” has been identified, it is expressed in the form of a two-dimensional (2D) motion vector (Δy, Δy), where Δx is the horizontal and Δy is the vertical displacement of the position of the predictive block in the reference frame relative to the position of the block to be coded.

The motion vectors together with the reference frame are used to construct predicted block F_{pred} as follows:

F_{pred}(x,y)=F_{ref}(x+Δx, y+Δy)

The location of a pixel within the frame is denoted by (x, y).

For blocks encoded in I-mode, the predicted block is formed using spatial prediction from previously encoded neighboring blocks within the same frame. For both I-mode and P- or B-mode, the prediction error, i.e., the residual difference between the pixel values in the block being encoded and the predicted block, is represented as a set of weighted basis functions of some discrete transform, such as a discrete cosine transform (DCT). Transforms may be performed based on different sizes of blocks, such as 4×4, 8×8 or 16×16 and larger. The shape of the transform block is not always square. Rectangular shaped transform blocks can also be used, e.g. with a transform block size of 16×4, 32×8, etc.

The weights (i.e., the transform coefficients) are subsequently quantized. Quantization introduces a loss of information, and as such, quantized coefficients have lower precision than the original transform coefficients. Quantized transform coefficients and motion vectors are examples of “syntax elements.” These syntax elements, plus some control information, form a coded representation of the video sequence. Syntax elements may also be entropy coded, thereby further reducing the number of bits needed for their representation. Entropy coding is a lossless operation aimed at minimizing the number of bits required to represent transmitted or stored symbols (in our case syntax elements) by utilizing properties of their distribution (some symbols occur more frequently than others).

In the decoder, the block in the current frame is obtained by first constructing its prediction in the same manner as in the encoder, and by adding to the prediction the compressed prediction error. The compressed prediction error is found by weighting the transform basis functions using the quantized coefficients. The difference between the reconstructed frame and the original frame is called reconstruction error.

The compression ratio, i.e., the ratio of the number of bits used to represent the original sequence and the compressed one, may be controlled by adjusting one or both of the value of the quantization parameter (QP) and the values in a quantization matrix, both of which may be used to quantize transform coefficients. The compression ratio may depend on the method of entropy coding employed.

For video coding according to the high efficiency video coding (HEVC) standard currently under development by the Joint Cooperative Team for Video Coding (JCT-VC), as one example, a video frame may be partitioned into coding units. A coding unit (CU) generally refers to an image region that serves as a basic unit to which various coding tools are applied for video compression. A CU usually has a luminance component, denoted as Y, and two chroma components, denoted as U and V. Depending on the video sampling format, the size of the U and V components, in terms of number of samples, may be the same as or different from the size of the Y component. A CU is typically square, and may be considered to be similar to a so-called macroblock, e.g., under other video coding standards such as ITU-T H.264. Coding according to some of the presently proposed aspects of the developing HEVC standard will be described in this application for purposes of illustration. However, the techniques described in this disclosure may be useful for other video coding processes, such as those defined according to H.264 or other standard or proprietary video coding processes.

HEVC standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-five intra-prediction encoding modes. A recent latest Working Draft (WD) of HEVC, and referred to as HEVC WD7 hereinafter, is available from http://phenix.int-evey.fr/jct/doc_end_user/documents/9 Geneva/wg11/JCTVC-I1003-v6.zip.

According to the HM, a CU may include one or more prediction units (PUs) and/or one or more transform units (TUs). Syntax data within a bitstream may define a largest coding unit (LCU), which is a largest CU in terms of the number of pixels. In general, a CU has a similar purpose to a macroblock of H.264, except that a CU does not have a size distinction. Thus, a CU may be split into sub-CUs. In general, references in this disclosure to a CU may refer to a largest coding unit of a picture or a sub-CU of an LCU. An LCU may be split into sub-CUs, and each sub-CU may be further split into sub-CUs. Syntax data for a bitstream may define a maximum number of times an LCU may be split, referred to as CU depth. Accordingly, a bitstream may also define a smallest coding unit (SCU). This disclosure also uses the term “block”, “partition,” or “portion” to refer to any of a CU, PU, or TU. In general, “portion” may refer to any sub-set of a video frame.

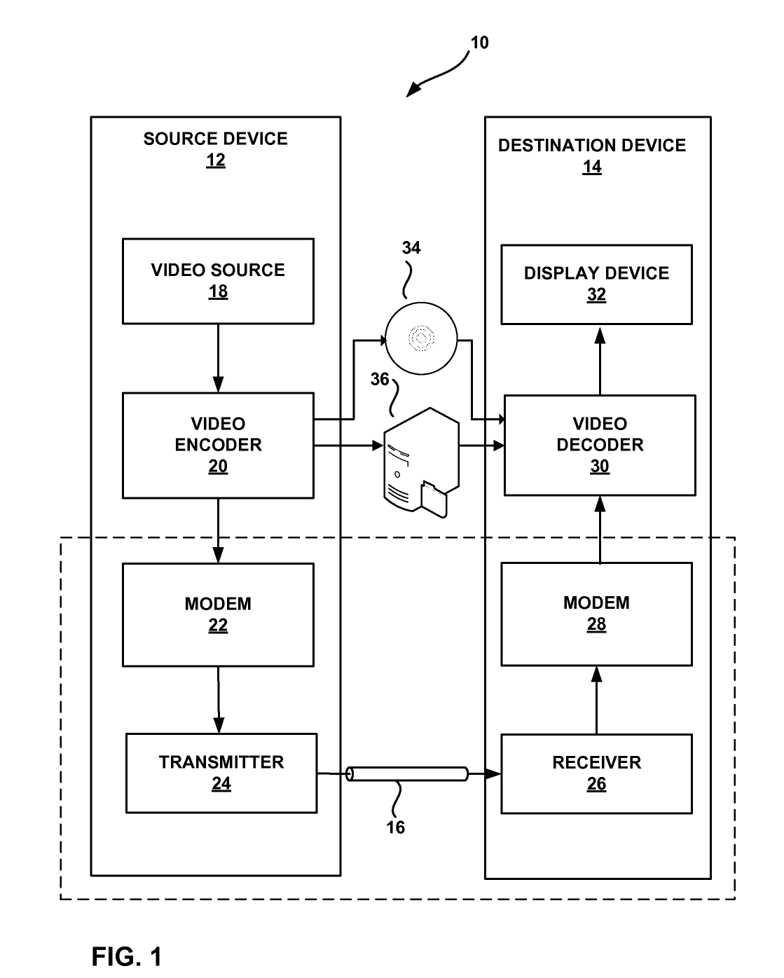

FIG. 1 is a block diagram illustrating an example video encoding and decoding system 10 that may be configured to utilize techniques for coding non-symmetric distributions of video data and/or techniques for quantization matrix compression, as described in this disclosure. As shown in FIG. 1, system 10 includes a source device 12 that transmits encoded video to a destination device 14 via a communication channel 16. Encoded video data may also be stored on a storage medium 34 or a file server 36 and may be accessed by destination device 14 as desired. When stored to a storage medium or a file server, video encoder 20 may provide coded video data to another device, such as a network interface, a compact disc (CD), Blu-ray or digital video disc (DVD) burner or stamping facility device, or other devices, for storing the coded video data to the storage medium. Likewise, a device separate from video decoder 30, such as a network interface, CD or DVD reader, or the like, may retrieve coded video data from a storage medium and provided the retrieved data to video decoder 30.

Source device 12 and destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In some cases, one or both of source device 12 and destination device 14 may be a wireless communication device equipped for wireless communication, such as, e.g., a mobile phone handset. Hence, communication channel 16 may comprise a wireless channel, a wired channel, or a combination of wireless and wired channels suitable for transmission of encoded video data. Similarly, file server 36 may be accessed by destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

The techniques described in this disclosure, including the techniques for coding non-symmetric distributions of video data and the techniques for quantization matrix compression, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, a video encoder 20, a modulator/demodulator 22 and a transmitter 24. In source device 12, the video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if the video source 18 is a video camera, source device 12 and destination device 14 may form so-called camera phones or video phones. However, the techniques described in this disclosure may be applicable to video coding in general, and may be applied to wireless and/or wired applications, or application in which encoded video data is stored on a local disk.

The captured, pre-captured, or computer-generated video may be encoded by video encoder 20. The encoded video information may be modulated by the modem 22 according to a communication standard, such as a wireless communication protocol, and transmitted to destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The captured, pre-captured, or computer-generated video that is encoded by video encoder 20 may also be stored onto a storage medium 34 or a file server 36 for later consumption. Storage medium 34 may include Blu-ray discs, DVDs, CD-ROMs, flash memory, or any other suitable digital storage media for storing encoded video. The encoded video stored on storage medium 34 may then be accessed by destination device 14 for decoding and playback.

File server 36 may be any type of server capable of storing encoded video and transmitting that encoded video to destination device 14. Example file servers include a web server (e.g., for a website), an FTP server, network attached storage (NAS) devices, a local disk drive, or any other type of device capable of storing encoded video data and transmitting it to a destination device. The transmission of encoded video data from file server 36 may be a streaming transmission, a download transmission, or a combination of both. File server 36 may be accessed by destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

Destination device 14, in the example of FIG. 1, includes a receiver 26, a modem 28, a video decoder 30, and a display device 32. Receiver 26 of destination device 14 receives information over the channel 16, and the modem 28 demodulates the information to produce a demodulated bitstream for video decoder 30. The information communicated over the channel 16 may include a variety of syntax information (e.g., syntax elements) generated by video encoder 20 for use by video decoder 30 in decoding video data. Such syntax may also be included with the encoded video data stored on storage medium 34 or file server 36. Each of video encoder 20 and video decoder 30 may form part of a respective encoder-decoder (CODEC) that is capable of encoding or decoding video data.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

In the example of FIG. 1, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14.

Video encoder 20 and video decoder 30 may operate according to a video compression standard, such as the HEVC standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples include MPEG-2 and ITU-T H.263.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

Video encoder 20 may implement any or all of the techniques of this disclosure. For example, video encoder 20 may be configured to convert a set of source symbols selected from a source symbol alphabet to a set of mapped symbols selected from a mapped symbol alphabet based on a mapping between symbol values in the source symbol alphabet and symbol values in the mapped symbol alphabet, and to encode the mapped symbols based on a variable length code to generate an encoded bitstream that includes variable length code words. The symbol values in the source symbol alphabet may include positive symbol values and negative symbol values. Each of the symbol values in the mapped symbol alphabet may be a non-negative symbol value. In some examples, the mapping may bias lower symbol values of the mapped symbol alphabet toward positive symbol values of the source symbol alphabet. In further examples, the mapping may bias lower symbol values of the mapped symbol alphabet toward negative symbol values of the source symbol alphabet.

In some examples, the source symbols may include symbols that correspond to prediction residuals for a plurality of values in a quantization matrix. In such examples, video encoder 20 may be configured to encode a first value in a quantization matrix based on a predictor that is equal to a maximum of a second value and a third value in the quantization matrix to generate a prediction residual for the first value in the quantization matrix. The other prediction residuals for the plurality of values in a quantization matrix may be encoded in a similar fashion based on similar predictors. In further examples, video encoder 20 may be configured to scan the values of the quantization matrix in a raster scan order to produce a set of scanned quantization matrix values. In such examples, the first, second, and third values in the quantization matrix may be first, second, and third scanned values from the set of scanned quantization matrix values. It should be noted that the adjectives “first,” “second,” and “third” are used merely for distinguishing between three different values in the quantization matrix and do not, in and of themselves, denote any particular ordering of the values within the quantization matrix.

Similarly, video decoder 30 may implement any or all of these techniques. For example, video decoder 30 may be configured to decode mapped symbols from an encoded bistream that includes variable length codewords based on a variable length code, and to convert the set of mapped symbols to a set of source symbols based on a mapping between symbol values in a source symbol alphabet and symbol values in a mapped symbol alphabet. Each of the symbols in the set of mapped symbols may be selected from a mapped symbol alphabet, and each of the symbols in the set of source symbols may be selected from a source symbol alphabet. The symbol values in the source symbol alphabet may include positive symbol values and negative symbol values. Each of the symbol values in the mapped symbol alphabet may be a non-negative symbol value. The mapping may bias lower symbol values of the mapped symbol alphabet toward positive symbol values of the source symbol alphabet or negative symbol values of the source symbol alphabet.

In some examples, the source symbols may include symbols that correspond to prediction residuals for a plurality of values in a quantization matrix. In such examples, video decoder 30 may be configured to decode a first value in a quantization matrix based on a predictor that is equal to a maximum of a second value and a third value in the quantization matrix based on a prediction residual corresponding to the first value in the quantization matrix. In further examples, the values of the quantization matrix may have been scanned by video encoder 20 in a raster scan order. In such examples, the first, second, and third values in the quantization matrix may be first, second, and third scanned values from the set of scanned quantization matrix values, and video decoder 30 may be configured to inverse scan the decoded scanned quantization matrix values to produce a block of quantization matrix values. Again, it should be noted that the adjectives “first,” “second,” and “third” are used merely for distinguishing between three different values in the quantization matrix and do not, in and of themselves, denote any particular ordering of the values within the quantization matrix.

A video coder, as described in this disclosure, may refer to a video encoder or a video decoder. Similarly, a video coding unit may refer to a video encoder or a video decoder. Likewise, video coding may refer to video encoding or video decoding.

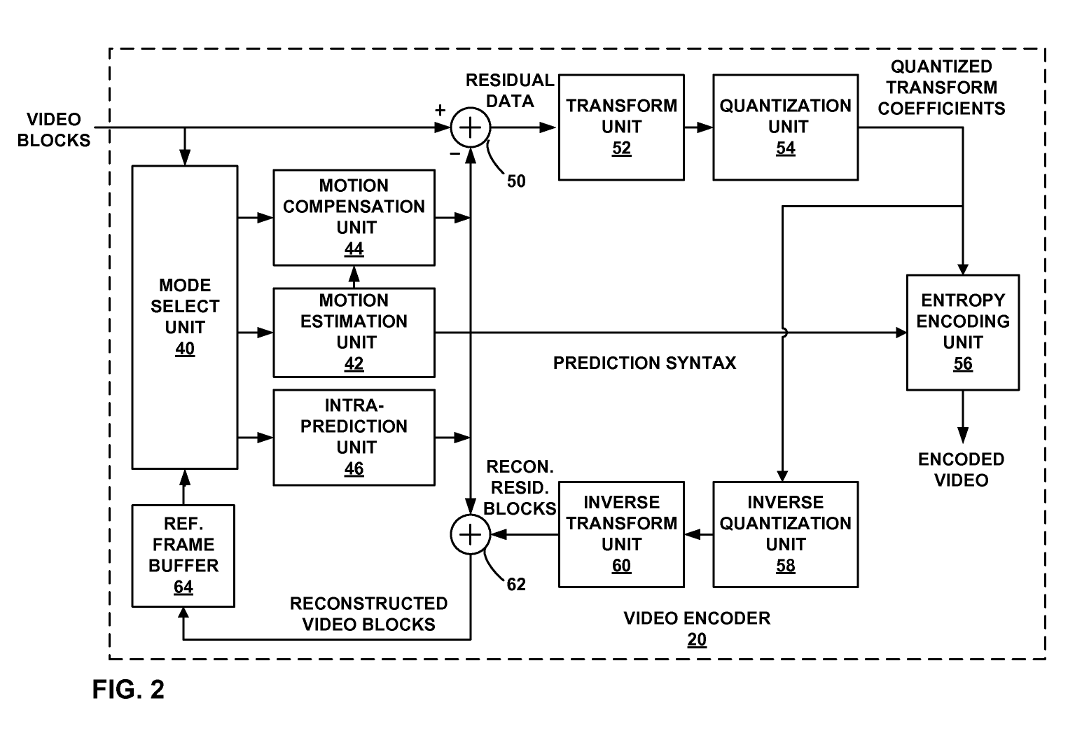

FIG. 2 is a block diagram illustrating an example of a video encoder 20 that may be configured to utilize techniques for coding non-symmetric distributions of video data and/or techniques for quantization matrix compression, as described in this disclosure. Video encoder 20 will be described in the context of HEVC coding for purposes of illustration, but without limitation of this disclosure as to other coding standards or methods. Video encoder 20 may perform intra- and inter-coding of CUs within video frames. Intra-coding relies on spatial prediction to reduce or remove spatial redundancy in video data within a given video frame. Inter-coding relies on temporal prediction to reduce or remove temporal redundancy between a current frame and previously coded frames of a video sequence. Intra-mode (I-mode) may refer to any of several spatial-based video compression modes. Inter-modes such as uni-directional prediction (P-mode) or bi-directional prediction (B-mode) may refer to any of several temporal-based video compression modes.

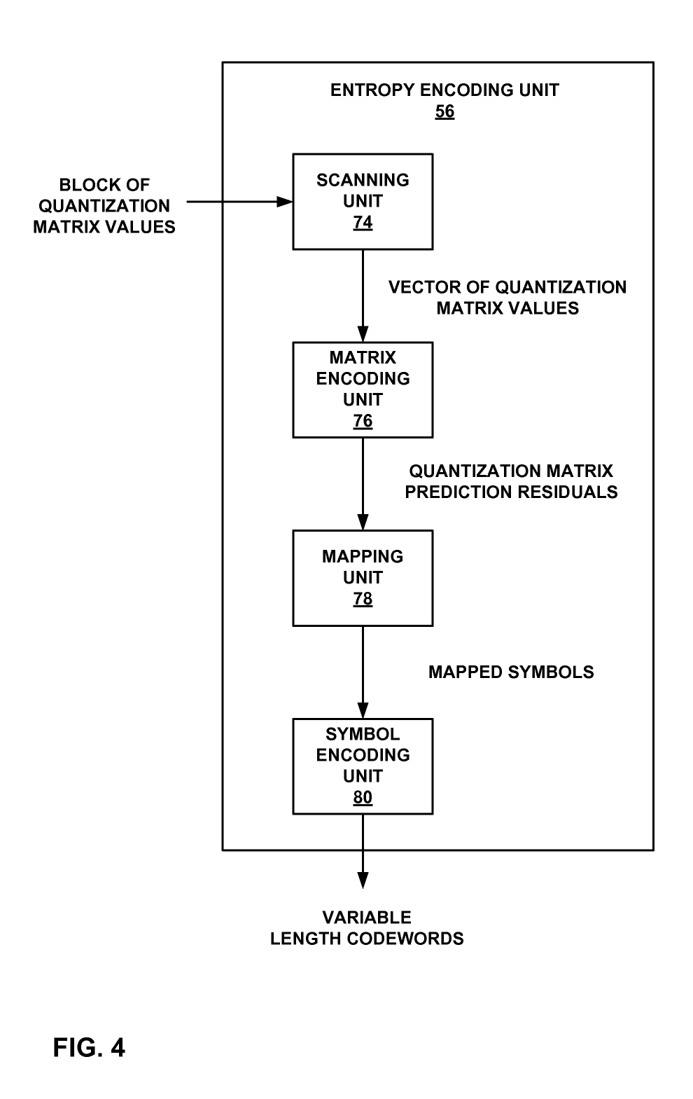

As shown in FIG. 2, video encoder 20 receives a current video block within a video frame to be encoded. In the example of FIG. 2, video encoder 20 includes a motion compensation unit 44, a motion estimation unit 42, an intra-prediction unit 46, a reference frame buffer 64, a summer 50, a transform unit 52, a quantization unit 54, and an entropy encoding unit 56. Transform unit 52 illustrated in FIG. 2 is the unit that applies an actual transform or combinations of transforms to a block of residual data, and is not to be confused with block of transform coefficients, which also may be referred to as a transform unit (TU) of a CU. For video block reconstruction, video encoder 20 also includes an inverse quantization unit 58, an inverse transform unit 60, and a summer 62. A deblocking filter (not shown in FIG. 4) may also be included to filter block boundaries to remove blockiness artifacts from reconstructed video. If desired, the deblocking filter may be used to filter the output of summer 62.

During the encoding process, video encoder 20 receives a video frame or slice to be coded. The frame or slice may be divided into multiple video blocks, e.g., largest coding units (LCUs). Motion estimation unit 42 and motion compensation unit 44 perform inter-predictive coding of the received video block relative to one or more blocks in one or more reference frames to provide temporal compression. Intra-prediction unit 46 may perform intra-predictive coding of the received video block relative to one or more neighboring blocks in the same frame or slice as the block to be coded to provide spatial compression.

Mode select unit 40 may select one of the coding modes, intra or inter, e.g., based on error (i.e., distortion) results for each mode, and provide the resulting intra- or inter-predicted block (e.g., a prediction unit (PU)) to summer 50 to generate residual block data and to summer 62 to reconstruct the encoded block for use in a reference frame. Summer 62 combines the predicted block with inverse quantized, inverse transformed data from inverse transform unit 60 for the corresponding block to reconstruct the encoded block, as described in greater detail below. Some video frames may be designated as I-frames, where all blocks in an I-frame are encoded in an intra-prediction mode. In some cases, intra-prediction unit 46 may perform intra-prediction encoding of a block in a P- or B-frame, e.g., when motion search performed by motion estimation unit 42 does not result in a sufficient prediction of the block.

In some examples, mode select unit 40 and/or another component in video encoder 20 may provide quantization matrix information to quantization unit 54 and/or inverse quantization unit 58. The quantization matrix information may specify a quantization matrix for use by quantization unit 54 when quantizing transformed coefficients generated by transform unit 52 and/or for use by inverse quantization unit 58 when performing inverse quantization with respect to quantized transform coefficients generated by quantization unit 54. In some examples, the quantization matrix information may include actual quantization matrix values. In additional examples, the quantization matrix information may include an index that is indicative of a predetermined quantization matrix and/or an index that is indicative of a technique for adaptively determining a set of quantization matrix values for a given set of video blocks.

In some examples, the quantization matrix provided to quantization unit 54 and/or to inverse quantization unit 58 may be generated by video encoder 20 or another component based on a contrast sensitivity function and/or a model of a contrast sensitivity function. In such examples, a single quantization matrix may, in some examples, be used for an entire sequence of frames and/or video blocks. However, a quantization matrix that is determined in such a manner may not correspond to the default quantization matrices defined by one or more video coding standards, such as, e.g., HEVC or AVC. In such cases, data that is indicative of each of the values in the quantization matrix may need to be sent to the decoder so that the decoder may use the appropriate quantization matrix for decoding one or more video blocks.

In further examples, the quantization matrix provided to quantization unit 54 and/or to inverse quantization unit 58 may be generated by video encoder 20 or another component based on a video scene analysis. For example, an encoder may divide a sequence of video frames into multiple scenes, and classify each of the scenes by scene type. For example, a scene may be classified as an action scene, a nature scene, a conversation scene, etc. In such examples, data that is indicative of each of the values in the quantization matrix may need to be sent to the decoder so that the decoder may use the appropriate quantization matrix for decoding one or more video blocks.

In additional examples, the quantization matrix provided to quantization unit 54 and/or to inverse quantization unit 58 may be generated by video encoder 20 or another component based on a video picture analysis and/or video frame analysis. For example, an encoder may analyze each picture and design a quantization matrix to minimize perceptual artifacts in the decoded picture. In such cases, data that is indicative of each of the values in the quantization matrix may need to be sent to the decoder so that the decoder may use the appropriate quantization matrix for decoding one or more video blocks.

In further examples, mode select unit 40 and/or another component in video encoder 20 may also provide scanning mode information to entropy encoding unit 56 or another component in video encoder 20 that performs scanning of video data. The scanning mode information may be indicative of a scan order to be used for scanning a block of video data. In some examples, the scanning mode information may be indicative of whether a raster scan order is to be used for scanning a block of video data.

Motion estimation unit 42 and motion compensation unit 44 may be highly integrated, but are illustrated separately for conceptual purposes. Motion estimation (or motion search) is the process of generating motion vectors, which estimate motion for video blocks. A motion vector, for example, may indicate the displacement of a prediction unit in a current frame relative to a reference sample of a reference frame. Motion estimation unit 42 calculates a motion vector for a prediction unit of an inter-coded frame by comparing the prediction unit to reference samples of a reference frame stored in reference frame buffer 64. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

Motion estimation unit 42 sends the calculated motion vector and other syntax elements to entropy encoding unit 56 and motion compensation unit 44. The portion of the reference frame identified by a motion vector may be referred to as a reference sample. Motion compensation unit 44 may calculate a prediction value for a prediction unit of a current CU, e.g., by retrieving the reference sample identified by a motion vector for the PU.

Intra-prediction unit 46 may perform intra-prediction on the received block, as an alternative to inter-prediction performed by motion estimation unit 42 and motion compensation unit 44. Intra-prediction unit 46 may predict the received block relative to neighboring, previously coded blocks, e.g., blocks above, above and to the right, above and to the left, or to the left of the current block, assuming a left-to-right, top-to-bottom encoding order for blocks. Intra-prediction unit 46 may be configured with a variety of different intra-prediction modes. For example, intra-prediction unit 46 may be configured with a certain number of directional prediction modes, e.g., thirty-five directional prediction modes, based on the size of the CU being encoded.

Intra-prediction unit 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, intra-prediction unit 46 may calculate an error value for the prediction mode based on pixel differences between the PU and the received block to be encoded. Intra-prediction unit 46 may continue testing intra-prediction modes until an intra-prediction mode that yields an acceptable error value is discovered. Intra-prediction unit 46 may then send the PU to summer 50.

Video encoder 20 forms a residual block by subtracting the prediction data calculated by motion compensation unit 44 or intra-prediction unit 46 from the original video block being coded. Summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded.

Transform unit 52 may form one or more transform units (TUs) based on the residual block. Transform unit 52 may select a transform from among a plurality of transforms to apply to the TUs. The transform may be selected based on one or more coding characteristics, such as block size, coding mode, or the like. Transform unit 52 then applies the selected transform to the TUs, producing a video block comprising a two-dimensional array of transform coefficients.

Applying a transform to a TU may refer to the process of transforming the residual data in the TU from a spatial domain (i.e. residual block) to a frequency domain (i.e. transform coefficient block). The spatial domain and the frequency domain are both typically two-dimensional domains. In some examples, a space-to-frequency transform operation (e.g., a discrete cosine transform (DCT), a discrete sine transform (DST), or an integer approximation of either the DCT or DST) may be subdivided into a core transform operation and a post-transform scaling operation. In such examples, transform unit 52 may perform the core transform operation on the TUs and allow the post-transform scaling operation to be performed in conjunction with the quantization of the transform coefficients. Transform unit 52 may signal the selected transform partition in the encoded video bitstream. Transform unit 52 may send the resulting transform coefficients to quantization unit 54.

Quantization unit 54 may then quantize the transform coefficients. Quantization may refer to the process of converting one or more the transform coefficients that have a first unit of precision to one or more quantized transform coefficients that have a second unit of precision where the second unit of precision is less than the first unit of precision. Stated differently, quantization may refer to the process of converting one or more transform coefficients to quantized transform coefficients where the quantized transform coefficient alphabet (i.e., the range of possible values for quantized transform coefficients) is smaller than the transform coefficient alphabet (i.e., the range of possible values for transform coefficients).

In some cases, quantization unit 54 may perform a post-transform scaling operation in addition to the quantization operation. The post-transform scaling operation may be used in conjunction with a core transform operation performed by transform unit 52 to effectively perform a complete space-to-frequency transform operation or an approximation thereof with respect to a block of residual data. In some examples, the post-transform scaling operation may be integrated with the quantization operation such that the post-transform operation and the quantization operation are performed as part of the same set of operations with respect to one or more transform coefficients to be quantized.

In some examples, quantization unit 54 may quantize transform coefficients based on a quantization matrix. The quantization matrix may include a plurality of values, each of which corresponds to a respective one of a plurality of transform coefficients in a transform coefficient block to be quantized. The values in the quantization matrix may be used to determine an amount of quantization to be applied by quantization unit 54 to corresponding transform coefficients in the transform coefficient block. For example, for each of the transform coefficients to be quantized, quantization unit 54 may quantize the respective transform coefficient according to amount of quantization that is determined at least in part by a respective one of the values in the quantization matrix that corresponds to the transform coefficient to be quantized.

In further examples, quantization unit 54 may quantize transform coefficients based on a quantization parameter and a quantization matrix. The quantization parameter may be a block-level parameter (i.e., a parameter assigned to the entire transform coefficient block) that may be used to determine an amount of quantization to be applied to a transform coefficient block. In such examples, values in the quantization matrix and the quantization parameter may together be used to determine an amount of quantization to be applied to corresponding transform coefficients in the transform coefficient block. In other words, the quantization matrix may specify values that, with a quantization parameter, may be used to determine an amount of quantization to be applied to corresponding transform coefficients. For example, for each of the transform coefficients to be quantized in a transform coefficient block, quantization unit 54 may quantize the respective transform coefficient according to amount of quantization that is determined at least in part by a block-level quantization parameter for the transform coefficient block and a respective one of a plurality of coefficient-specific values in the quantization matrix that corresponds to the transform coefficient to be quantized.

In some examples, the quantization process may include a process similar to one or more of the processes proposed for HEVC and/or defined by the H.264 decoding standard. For example, in order to quantize a transform coefficient, quantization unit 54 may scale the transform coefficient by a corresponding value in the quantization matrix and by a post-transform scaling value. Quantization unit 54 may then shift the scaled transform coefficient by an amount that is based on the quantization parameter. In some cases, the post-transform scaling value may be selected based on the quantization parameter. Other quantization techniques may also be used.

Quantization unit 54 may, in some examples, cause data indicative of a quantization matrix used by quantization unit 54 for quantizing transform coefficients to be included in an encoded bitstream. For example, quantization unit 54 may provide data indicative of a quantization matrix to entropy encoding unit 56 for entropy encoding the data and subsequent placement in an encoded bitstream.

The quantization matrix data included in the encoded bitstream may be used by video decoder 30 for decoding the bitstream (e.g., for performing an inverse quantization operation). In some examples, the data may be an index value that identifies a predetermined quantization matrix from a set of quantization matrices. In further examples, the data may include the actual values contained in the quantization matrix. In additional examples, the data may include a coded version of the actual values contained in the quantization matrix. For example, the coded version may be generated based on a predictor as described in further detail later in this disclosure. In some examples, the data may take the form of one or more syntax elements that specify a quantization matrix used by quantization unit 54 to quantize a transform coefficient block corresponding to a video block to be coded, and quantization unit 54 may cause the one or more syntax elements to be included in the header of the coded video block.

Although quantization unit 54 has been described herein as performing quantization using a quantization matrix, in other examples, quantization unit 54 may quantize transform coefficients without necessarily using a quantization matrix. For example, quantization unit 54 may quantize transform coefficients based solely on a quantization parameter or another parameter that specifies an amount of quantization.

Entropy encoding unit 56 is configured to entropy encode an incoming set of source symbols to produce an encoded video bitstream. The incoming set of source symbols that are coded by entropy encoding unit 56 may include, for example, quantized transform coefficients, quantization matrix values, quantization matrix prediction residuals, or any other type of syntax element, symbol, coefficients, or values that are used for coding video data. Entropy encoding may refer to the lossless encoding or compression of an incoming set of symbols such that the original data can be exactly reconstructed from the coded data without error. The codes used for entropy encoding are typically designed to exploit statistical properties or dependencies within an incoming set of source symbols such that the coded data has a bitrate that is less than the bitrate of the incoming set of symbols.

In some examples, the incoming set of source symbols may take the form of a two-dimensional block of source symbols (e.g., a two-dimensional block of quantized transformed coefficients or a two-dimensional block of quantization matrix prediction residuals). In other examples, the incoming set of source symbols may take the form of a one-dimensional vector of source symbols. A two-dimensional block of data may differ from a one-dimensional vector in that the two-dimensional block of data may be indexed in two different dimensions (e.g., row/column or horizontal/vertical) while the one-dimensional vector is indexed in a single dimension.

In examples where the incoming set of symbols corresponds to a two-dimensional block of symbols, entropy encoding unit 56 may scan the incoming set of source symbols prior to performing one or both of a pre-code mapping operation and a variable length coding operation. Scanning may refer to the process of converting a two-dimensional block of symbols into a one-dimensional vector of symbols. The one-dimensional vector of symbols that results from a scanning operation may be alternatively referred to herein as scanned symbols. In some examples, entropy encoding unit 56 may be configured to scan the coefficient values of a two-dimensional block of source symbols based on a raster scan order. Entropy encoding unit 56 may also be configured to scan the coefficient values of a two-dimensional block of source symbols using other scan orders, such as, e.g., a zig-zag scan order, a diagonal scan order, or a field scan order. In some examples, entropy encoding unit 56 may be configured to select a scan order based on information indicative of a type of syntax element to be coded and/or information indicative of a scan order mode (e.g., scan order mode information provided by mode select unit 40).

In some examples, entropy encoding unit 56 may entropy encode an incoming set of source symbols using a variable length code. The variable length code may map incoming source symbols to output codewords that have different or varying codeword lengths. In some cases, the variable length code may be configured to code a set of symbols such that relatively shorter codewords correspond to more likely symbols, while relatively longer codes correspond to less likely symbols.

The variable length codes used by entropy encoding unit 56 may, in some examples, be defined such that the incoming set of symbols to be coded is restricted to a symbol alphabet that contains only non-negative integer values and no negative integer values. Golomb codes, Golomb-Rice codes, exponential Golomb codes, or truncated versions of such codes are examples of codes that are often defined in such a manner. To encode a set of source symbols from a source symbol alphabet that includes negative symbol values, in such examples, entropy encoding unit 56 may remap the set of source symbol values to a set of mapped symbol values in a mapped symbol alphabet. The mapped symbols values are then encoded using a variable length code. The mapped symbol alphabet may correspond to the domain (i.e., the set of possible input symbol values) of the variable length code. Conventional remappings used in this context are typically not designed to efficiently encode non-symmetric distributions of source symbols that are skewed to favor of either positive or negative values.

According to some aspects of this disclosure, entropy encoding unit 56 may entropy encode a set of source symbols based on a mapping that is configured to bias either positive data values or negative data values of a signed integer source towards shorter codewords of a variable length code that codes non-negative integers. This may allow signed integer data sources that have probability distributions which are skewed in favor of either positive or negative values to be coded in a more efficient manner.

In some examples, entropy encoding unit 56 may be configured to convert (i.e., map) a set of source symbols selected from a source symbol alphabet to a set of mapped symbols selected from a mapped symbol alphabet based on a mapping between symbol values in the source symbol alphabet and symbol values in the mapped symbol alphabet. The mapping may bias lower symbol values of the mapped symbol alphabet toward positive symbol values of the source symbol alphabet or negative symbol values of the source symbol alphabet. The symbol values in the source symbol alphabet may include positive symbol values and negative symbol values. Each of the symbol values in the mapped symbol alphabet may be a non-negative symbol value. In such examples, entropy encoding unit 56 may be further configured to entropy encode the mapped symbols based on a variable length code to generate an entropy encoded signal that includes variable length codewords. In some examples, the variable length code may be a variable length code from the Golomb family, such as, e.g., a Golomb code, Golomb-Rice code, an exponential Golomb code, or a truncated version of such codes. The variable length code may assign relatively shorter codewords to relatively lower-valued symbols in the mapped symbol alphabet.

In some examples, the mapping may bias lower symbol values of the mapped symbol alphabet toward positive symbol values of the source symbol alphabet. In such examples, the mapping may be biased in the sense that more positive source symbol values are assigned to lower values of the mapped symbol alphabet than non-positive source symbol values. For example, for a set of L lowest-valued symbol values in the mapped symbol alphabet, the mapping may assign more positive symbol values in the source symbol alphabet than non-positive symbol values in the source symbol alphabet to the set of L lowest-valued symbol values for at least one L where L is an integer greater than or equal to two. As another example, for a set of K lowest-valued symbol values in the mapped symbol alphabet, the number of positive source symbols that are assigned by the mapping to the set of K lowest-valued symbol values in the mapped symbol alphabet may be greater than K/2 for at least one K where K is an integer greater than or equal to two.

In further examples, the mapping may bias lower symbol values of the mapped symbol alphabet toward negative symbol values of the source symbol alphabet. In such examples, the mapping may be biased in the sense that more negative source symbol values are assigned to lower values of the mapped symbol alphabet than non-negative source symbol values. For example, for a set of L lowest-valued symbol values in the mapped symbol alphabet, the mapping may assign more negative symbol values in the source symbol alphabet than non-negative symbol values in the source symbol alphabet to the set of L lowest-valued symbol values for at least one L where L is an integer greater than or equal to two. As another example, for a set of K lowest-valued symbol values in the mapped symbol alphabet, the number of negative source symbols that are assigned by the mapping to the set of K lowest-valued symbol values in the mapped symbol alphabet may be greater than K/2 for at least one K where K is an integer greater than or equal to two.

Other mappings are also possible as will be described in further detail later in this disclosure. Although entropy encoding unit 56 has been described herein as performing a mapping operation prior to performing variable length coding with respect to an incoming symbol set, in other examples, entropy encoding unit 56 may not necessarily perform a mapping prior to entropy coding an incoming symbol set.

According to additional aspects of this disclosure, entropy encoding unit 56 may code and/or compress a quantization matrix based on a predictor definition that is configured to generate prediction residuals for the quantization matrix that are skewed in favor of positive values, and cause the coded version of the quantization matrix to be placed in a coded bitstream. The predictor definition may define a predictor for a value to be coded in the quantization matrix based on values in the quantization matrix that have horizontal and vertical frequency components that are less than or equal to the horizontal and vertical frequency components of the value to be coded. In other words, for a value to be coded in a quantization matrix, entropy encoding unit 56 may generate a prediction for coding the value based on one or more values in the quantization matrix, other than the value to be coded, that have horizontal frequency components less than or equal to the horizontal frequency component corresponding to the value to be coded and vertical frequency components less than or equal to the vertical frequency component of the value to be coded.

In some examples, entropy encoding unit 56 may encode a first value in a quantization matrix based on a predictor that is equal to a maximum of a second value and a third value in the quantization matrix in order to generate a prediction residual for the first value. The second value may have a position in the quantization matrix that is immediately left of a position corresponding to the first value in the quantization matrix. The third value may have a position in the quantization matrix that is immediately above the position corresponding to the first value in the quantization matrix. Quantization matrices are typically designed such that the coefficients generally, but not necessarily without exception, increase both in the row (left to right) and column (top to bottom) directions. Therefore, by using values in the quantization matrix that are to the left of and/or above a particular value to be encoded, the quantization matrix coding techniques of this disclosure may produce a set of prediction residuals that are skewed toward positive values. Producing a set of prediction residuals that are skewed toward positive values may allow specialized coding techniques that are designed to efficiently code non-symmetric distributions (e.g., the mapping techniques described in this disclosure) to be used to increase the coding efficiency of the resulting coded bitstream.

Entropy encoding unit 56 may map the quantization prediction residuals to a set of mapped symbols based on a mapping between source symbol values in a source symbol alphabet and symbol values in a mapped symbol alphabet, and entropy encode the mapped symbols based on a variable length code to generate an entropy encoded signal that includes variable length codewords. The mapping may bias lower symbol values of the mapped symbol alphabet toward positive symbol values of the source symbol alphabet according to the technique described in this disclosure. In some examples, the variable length code may be a code from the Golomb family of variable length codes, such as, e.g., a Golomb code, Golomb-Rice code, an exponential Golomb code, or a truncated version of such codes.

According to further aspects of this disclosure, entropy encoding unit 56 may be configured to scan quantization matrix values in a raster scan order prior to generating prediction residuals for the quantization matrix values. In some examples, in order to ensure that values for scan positions in a quantization matrix that are used to decode other scan positions in the quantization matrix have already been decoded prior to decoding the other scan positions in the quantization matrix that rely on the decoded values, the values in the quantization matrix may be decoded in a raster scan order. By also scanning the quantization matrix values in a raster scan order in the video encoder, in such examples, the quantization matrix values may be provided to the video decoder in the same order in which such values are to be decoded, thereby reducing the complexity of the video decoder. In addition, using a raster scan order for both the decoding and scanning of quantization matrix values may allow, in some examples, a pipelined implementation of the decoding and inverse scanning operations to be used in a decoder for decoding the quantization matrix, thereby increasing the coding performance of the system. For example, once a quantization matrix prediction residual has been decoded in a first stage, the decoded value may be passed on to a second stage to be inverse scanned without necessarily needing to wait for other scan positions to be decoded. This disclosure describes entropy encoding unit 56 as performing the scanning operation. However, it should be understood that, in other examples, other processing units, such as quantization unit 54, may perform the scanning operation.

In some examples, when coding a block of quantized transform coefficients, entropy encoding unit 56 may scan the two-dimensional block of quantized transform coefficients into a one-dimensional array (e.g., a one-dimensional vector) of quantized transform coefficients. Once the quantized transform coefficients are scanned into the one-dimensional array, entropy encoding unit 56 may apply entropy coding such as context-adaptive variable-length coding (CAVLC), context-adaptive binary arithmetic coding (CABAC), syntax-based context-adaptive binary arithmetic coding (SBAC), or another entropy coding methodology to the coefficients.

To perform CAVLC, entropy encoding unit 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted.

To perform CABAC, entropy encoding unit 56 may binarize incoming symbols that are not already in binary form, and code the binarized symbols using one or more context models. In some examples, for each binarized symbol, entropy encoding unit 56 may select a context model from a set of context models to encode a first bin (i.e., the first bit) in the symbol based on previously coded symbols. In such examples, entropy encoding unit 56 may select a predetermined context model to encode subsequent bins of symbol. Entropy encoding unit 56 may encode each of the bins using an arithmetic coding methodology based on the selected and predetermined context models. Each of the context models may contain information indicative of a probability of a bin to be encoded containing to a one or zero. The probabilities may be based on, for example, whether bins for previously coded symbol values are non-zero or not. After encoding a symbol, the context models may be updated and scaled based on the symbol that was most recently encoded. CABAC may provide improved coding efficiency compared to CAVLC, but typically at the expense of greater computational complexity.

Entropy encoding unit 56 may also entropy encode other types of syntax elements, such as, e.g., the signal representative of the selected transform by transform unit 52, coded block pattern (CBP) values for CU's and PU's, and quantization matrix prediction residuals. With respect to quantization matrix prediction residuals, for example, entropy encoding unit 56, or other processing units, may also code other data, such as the values of a quantization matrix using the mapping techniques described in this disclosure. For example, entropy coding unit 56 may code the quantization matrix values using variable length codes such as Golomb, Golomb-Rice or exponential Golomb codes, or truncated versions of such codes, or other codes, with a modified mapping that utilize an offset and a scaling factor to modify the mapping of source symbols to remapped symbols for determination of variable length codes. In additional examples, entropy encoding unit 56 may apply similar coding to techniques to other syntax elements in addition to or in lieu of quantization prediction residuals. Following the entropy coding by entropy encoding unit 56, the resulting encoded video may be transmitted to another device, such as video decoder 30, or archived for later transmission or retrieval.

In some cases, entropy encoding unit 56 or another unit of video encoder 20 may be configured to perform other coding functions. For example, entropy encoding unit 56 may be configured to determine coded block pattern (CBP) values for CU's and PU's. Also, in some cases, entropy encoding unit 56 may perform run length coding of coefficients.

Inverse quantization unit 58 and the inverse transform unit 60 apply inverse quantization and inverse transformation, respectively, to reconstruct the residual block in the pixel domain, e.g., for later use as a reference block. For example, inverse quantization unit 58 may inverse quantize the quantized transform coefficients generated by quantization unit 54 in order to produce a set of reconstructed transform coefficients. In some examples, inverse quantization unit 58 may inverse quantize the quantized transform coefficients based on one or both of a quantization matrix and a quantization parameter. In this case, the quantization matrix and/or quantization parameter may be used to determine a degree of inverse quantization to be performed by inverse quantization unit 58 on the quantized transform coefficients. In some examples, the quantization matrix used by inverse quantization unit 58 to perform inverse quantization may be the same as the quantization matrix used by quantization unit 54 to perform quantization. Similarly, the quantization parameter used by inverse quantization unit 58 to perform inverse quantization may be the same as the quantization parameter used by quantization unit 54 to perform quantization. Inverse quantization unit 58 may receive quantization matrix information and quantization parameter information from one or more syntax elements that specify such information (e.g., one or more syntax elements generated by mode select unit 40 and/or another component with video encoder 20).

In some cases, inverse quantization unit 58 may perform a pre-transform scaling operation in addition the quantization operation. The pre-transform scaling operation may be used in conjunction with a core transform operation performed by inverse transform unit 60 to effectively perform a complete inverse space-to-frequency transform operation (i.e., a frequency-to-space transform operation) or an approximation thereof with respect to a block of quantized transform coefficients. In some examples, the pre-transform scaling operation may be integrated with the inverse quantization operation performed by inverse quantization unit 58 such that the pre-transform operation and the quantization operation are performed as part of the same set of operations with respect to a quantized transform coefficient to be inverse quantized.

Inverse transform unit 60 may be configured to apply an inverse transform to the set of reconstructed transform coefficients to produce a reconstructed residual block. In some examples, the inverse transform may be an inverse of the transform performed by transform unit 52. In examples where the space-to-frequency transform operation performed by the encoding stage of video encoder 20 may be subdivided into a core transform operation and a post-transform scaling operation, the inverse transform may also be subdivided into a pre-transform scaling operation and a core transform operation. In such cases, inverse transform unit 60 may allow the pre-transform scaling operation to be performed by inverse quantization unit 58 in conjunction with the inverse quantization of the quantized transform coefficients, and may perform the core transform operation on the pre-scaled reconstructed transform coefficients.

Motion compensation unit 44 may calculate a reference block by adding the reconstructed residual block to a predictive block of one of the frames of reference frame buffer 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame buffer 64. The reconstructed video block may be used by motion estimation unit 42 and motion compensation unit 44 as a reference block to inter-code a block in a subsequent video frame.

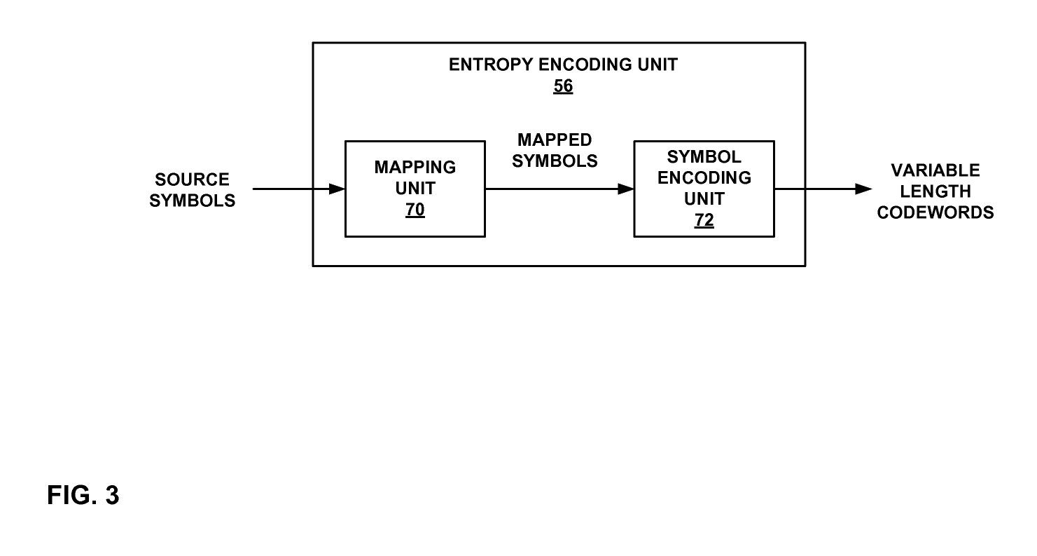

FIG. 3 is a block diagram illustrating an example entropy encoding unit 56 that may be used in the video encoder 20 of FIG. 2. Entropy encoding unit 56 includes a mapping unit 70 and a symbol encoding unit 72. Mapping unit 70 is configured to convert (e.g., map) a set of source symbols to a set of mapped symbols based on a mapping between symbol values in a source symbol alphabet and symbol values in a mapped symbol alphabet. Symbol encoding unit 72 is configured to encode the mapped symbols based on a variable length code to generate an encoded signal that includes variable length code words.

The mapped symbol alphabet used for the mapping performed by mapping unit 70 may correspond to the domain of the variable length code (i.e., the set of possible input values for the variable length code) used by symbol encoding unit 72, while the source symbol alphabet may contain one or more values that are outside of the domain of the variable length code. For example, the domain of the variable length code may be a set of non-negative integers, and the source symbol alphabet may contain negative integers in addition to non-negative integers.

In some examples, mapping unit 70 may be configured to selectively apply one of a plurality of different mappings to an incoming set of symbols. For example, mapping unit 70 may select a mapping to apply to a set of incoming symbols based on information indicative of a type of syntax element to be coded, information indicative of a prediction mode associated with the set of symbols to be coded, and/or information indicative of a mapping mode to be used for coding the data (e.g., mapping mode information provided by mode select unit 40 or another component in video encoder 20). In further examples, mapping unit 70 may be selectively disabled such that no mapping of the source symbols to mapped symbols occurs prior to the source symbols being coded by symbol encoding unit 72. In other words, in such examples, the source symbols may be passed directly to symbol encoding unit 72 for variable length coding.

Golomb, Golomb-Rice and exponential Golomb codes are examples of variable length codes used to code non-negative integers (i.e., the domain of the code corresponds to non-negative integers). When the source to be encoded contains negative integers as well, a remapping of the source symbols to non-negative integers may be necessary. One such commonly used mapping is shown in Table 1 below. In particular, Table 1 shows a typical remapping of signed integers to unsigned integers.

TABLE 1

| Source symbol (X) | Remapped symbol (Y) |
|---|---|
| 0 | 0 |
| 1 | 1 |
| −1 | 2 |
| 2 | 3 |
| −2 | 4 |
| 3 | 5 |
| −3 | 6 |
| . . . | . . . |

All of the codes in the Golomb family assign shorter codewords to smaller non-negative integers. An example of a Golomb code is shown in Table 2 for Golomb parameter of 2. Table 2 shows an example of the Golomb codes assigned to remapped symbols (Y) of Table 1.

TABLE 2

| Remapped symbol (Y) | Golomb code |
|---|---|
| 0 | 00 |
| 1 | 01 |
| 2 | 100 |
| 3 | 101 |
| 4 | 1100 |
| 5 | 1101 |
| . . . | . . . |

In one example, a video encoder may encode a source X that can take integer values which are typically increasing monotonically. However, this is not always guaranteed. In such a case, if first order prediction (prediction from a previous sample in scan order) is used, the prediction error is typically non-negative. As an illustration, consider one of the example quantization matrix compression techniques described in this disclosure that may use a predictor which is equal to the maximum of a value immediately to the left of the current scan position and a value immediately above the current scan position. Because the quantization matrix values generally, but not necessarily without exception, increase in the horizontal and vertical directions, the prediction errors for the proposed predictor are generally non-negative. There may be a few instances, however, where the prediction error is negative. In such a case, the remapping of symbols shown in Table 1 may be wasteful, as relatively short codewords are assigned to relatively rarely occurring negative prediction error values.

This disclosure describes a remapping technique that is more suitable when the probability distribution of symbols is skewed to favor positive numbers, resulting in a non-symmetric distribution of symbols between positive and negative values. This modified remapping technique may be biased, in some examples, such that lower values of the remapped symbols (Y) are biased toward positive values of the source symbols (X). In additional examples, the mapping technique described in this disclosure may make use of an offset and a scaling factor to adjust the mapping of source symbols (X) to remapped symbols (Y). This different mapping of the source symbol X to Y may result in more efficient coding for a set of symbols having a probability distribution that is skewed toward positive values. Let offset and m be two parameters specifying the mapping where offset>0 and m>1. Then, the mapping of source symbols X to remapped symbols Y, in some examples, may be specified by equation (1) as:

For X<0 Y=offset+(−X−1)*m

For 0≦X<offset Y=X (1)

For X≧offset Y=X+└(X−offset)/(m−1)┘+1

where the operator └x┘ means the largest integer that is less than or equal to x. In equation (1), the offset is an integer greater than zero and m is an integer greater than or equal to two. In some examples, one or both of the offset and m may be predetermined values.

Table 3 shows an example of the remapping of source symbols X to remapped symbols Y for offset=4 and m=3. The remapped symbol Y can then be represented with a Golomb code as in Table 2. For example, video encoder 20 may map the source symbols X to remapped symbols Y according to Table 3 below, and then select the Golomb codes in Table 2 for the remapped symbols Y. Video decoder 30 may receive the Golomb-coded code words, and map the codewords to remapped symbols Y according to Table 2. Then, video decoder 30 may use Table 3 to map the remapped symbols Y to the source symbols X according to Table 3, to thereby obtain the source symbols X.

TABLE 3

| Source symbol (X) | Remapped symbol (Y) |
|---|---|
| 0 | 0 |
| 1 | 1 |
| 2 | 2 |
| 3 | 3 |
| −1 | 4 |
| 4 | 5 |
| 5 | 6 |
| −2 | 7 |
| 6 | 8 |
| 7 | 9 |
| . . . | . . . |

It should be noted that for offset=2 and m=2, the proposed mapping may be equivalent to the more usual mapping shown in Table 1. Higher values of offsets and/or m lead to mappings that are more efficient for sources skewed towards positive values. Since the proposed mapping is one-to-one, video decoder 30 may use the inverse mapping to go from Y to X.

In general, using this technique for remapping, a method of coding video data may comprise mapping a set of source symbols (X) to a set of remapped symbols (Y), wherein the mapping biases lower values of the remapped symbols (Y) toward positive values of the source symbols (X), and coding the remapped symbols (Y) using corresponding variable length code words, such codewords defined according to one of Golomb, Golomb-Rice or exponential Golomb coding. The mapping may bias lower values of the remapped symbols (Y) toward positive values of the source symbols (X) in the sense that more positive values of symbols (X) may be assigned to lower values of the remapped symbols (Y) than non-positive values, e.g., as shown in the example of Table 3. In some examples, the mapping may assign more positive source symbol values (X) than negative source symbol values (X) to lower values of the remapped symbols (Y).

For example, for a set of L lowest-valued symbol values in the mapped symbol alphabet, the mapping may assign more positive symbol values in the source symbol alphabet than non-positive symbol values in the source symbol alphabet to the set of L lowest-valued symbol values in the mapped symbol alphabet for at least one L where L is selected from the set of integers greater than or equal to two. For instance, consider the mapping in Table 3 and the case where L=3. In such an example, the three lowest-valued mapped symbols (Y) are {0, 1, 2}. Table 3 illustrates that two positive source symbols (X={1, 2}) and one non-positive source symbol (X={0}) are mapped to the three lowest-valued mapped symbols (Y). Thus, for at least one L (e.g., L=3) where L is selected from the set of integers greater than or equal to two, more positive symbol values in the source symbol alphabet than non-positive symbol values in the source symbol alphabet are mapped to the set of L lowest-valued symbol values in the mapped symbol alphabet.

In general, when this disclosure refers to a set of L lowest-valued symbol values in a mapped symbol alphabet, this disclosure may be referring to a set of L symbol values in the mapped symbol alphabet where each of the L symbol values has a symbol value that is less than all of the other symbol values in mapped symbol alphabet that are not included in the set of L lowest-valued symbol values. The set of L lowest-valued symbol values may be alternatively referred to as the L lowest-values symbol values in the mapped symbol alphabet without described the values as being a set. Similar principles apply in cases where another variable is used in place of “L.”

As another example, the number of positive source symbols assigned by the mapping to the K lowest-valued mapped symbols may be greater than K/2 for at least one K where K is selected from the set of integers greater than or equal to two. For instance, consider the mapping in Table 3 and the case where K=3. In such an example, the three lowest-valued mapped symbols (Y) are {0, 1, 2}. Table 3 illustrates that two positive source symbols (X={1, 2}) are mapped to the three lowest-valued mapped symbols (Y). Because three is greater than 3/2 (i.e., K/2), it may be said that, for at least one K (i.e., K=3) where K is selected from the set of integers greater than or equal to two, the number of positive source symbols assigned to the K lowest-valued mapped symbols is greater than K/2.

As a further example, the mapping may assign positive symbol values in the source symbol alphabet to at least two consecutive symbol values in the mapped symbol alphabet. For instance, the mapped symbols Y={1, 2} constitute two consecutive symbol values, both of which are mapped to positive source symbol values. Thus, the mapping in Table 3 may be said to assign positive symbol values in the source symbol alphabet to at least two consecutive symbol values in the mapped symbol alphabet.

In another example, for a set of N lowest-valued symbols in the mapped symbol alphabet, the mapping may assign a respective one of a plurality of non-negative symbol values in the source symbol alphabet to each of the symbol values in the set of N lowest-valued symbol values, where N is an integer greater than or equal to three. For instance, consider the mapping in Table 3 and the case where N=3. In such an example, the three lowest-valued mapped symbols (Y) are {0, 1, 2}. An inspection of Table 3 shows that non-negative source symbols (X={0, 1, 2}) are mapped to the three lowest-valued mapped symbols. Thus, for at least one N (i.e., N=3) where N is selected from the set of integers greater than or equal to three, the mapping may assign a respective one of a plurality of non-negative symbol values in the source symbol alphabet to each of the symbol values in the set of N lowest-valued symbol values. In some cases, N may be a programmable and/or configurable value.

In further examples, for at least a subset of the symbol values in the mapped symbol alphabet, the mapping may assign a respective one of a plurality of negative symbol values in the source symbol alphabet to every Mth symbol value in the subset of the symbol values, where M is an integer greater than or equal to three. In such examples, the mapping may also assign respective ones of a plurality of positive symbol values in the source symbol alphabet to the (M−1) symbol values in the mapped symbol alphabet that are between every Mth symbol value in the subset of the symbol values. For instance, consider the mapping in Table 3 and the case where M=3, starting at the mapped symbol Y={4} and counting upwards, a negative source symbol is mapped to every third symbol. Moreover, positive source symbol values are assigned to two symbol values between every third symbol value in the mapped symbol alphabet. In some cases, M may be a programmable and/or configurable value.

In some examples, the mapping of a negative symbol value to every Mth symbol in the mapped symbol alphabet may begin at the (N+1)th lowest symbol value in the mapped symbol alphabet and continue for symbol values greater than the (N+1)th lowest symbol value in the mapped symbol alphabet. In such examples, the mapping may, in some examples, assign non-negative source symbol values exclusively to the N lowest-valued symbol values in the mapped symbol alphabet.

The mapping techniques of this disclosure may apply an offset and a scaling factor to bias the lower values of the remapped symbols (Y) toward positive values of the source symbols (X). In some examples, the offset and scaling factor may be predetermined values. The offset may specify and/or control a number of lowest-valued symbols in the mapped symbol alphabet that are assigned to non-negative symbol values in the source symbol alphabet. The scaling factor may specify and/or control a distance between each of a plurality of symbol values in the mapped symbol alphabet that are assigned by the mapping to negative symbol values in the source symbol alphabet. In some cases, the scaling factor may apply to mapped symbol values that are greater than or equal to the offset and not apply to mapped symbol values that are less than the offset.

In some examples, the offset may specify that at least three lowest-valued symbols in the mapped symbol alphabet are to be assigned to non-negative symbol values in the source symbol alphabet. In further examples, the scaling factor may specify that negative source symbol values are to be assigned to mapped symbol values such that each mapped symbol value that is assigned to a negative source symbol is separated from another mapped symbol value that is assigned to a negative source symbol by a distance that is greater than or equal to three symbol values in the mapped symbol alphabet.

The values of the offset and the factor m may be fixed or variable, and may be selected by the encoder and signaled in the encoded bitstream, fixed and signaled by the encoder in the encoded bitstream, or fixed and known to both the encoder and decoder, e.g., by storing the values or pertinent mapping tables in memory. If the values are fixed, they may be determined, for example, by applying the coding techniques to a variety of source data with different offsets and scaling factors, and selecting an offset and scaling factor value that yields desirable results, e.g., in terms of a tradeoff between coding efficiency and quality.

As shown in Table 3, the mapped symbol alphabet used for the mapping performed by mapping unit 70 may correspond to the domain of the variable length code (i.e., the set of possible input values for the variable length code), while the source symbol alphabet may contain one or more values that are outside of the domain of the variable length code. For example, the domain of the variable length code may be a set of non-negative integers, and the source symbol alphabet may contain negative integers in addition to non-negative integers.

It should be noted that the remapping techniques described in this disclosure are applicable to truncated versions of Golomb, Golomb Rice and exponential Golomb codes. Similarly, the disclosed remapping techniques can be used in conjunction with any other code for non-negative integers that uses longer codewords for higher magnitude. Also, the disclosed remapping techniques may be applicable to any source generating symbols that are significantly skewed towards positive values. If a source X is significantly skewed towards negative values, the techniques could be applied to −X. In other words, by substituting (−X) for X in equation (1), a mapping that biases lower symbol values of the mapped symbol alphabet toward negative symbol values of the source symbol alphabet may be constructed.

FIG. 4 is a block diagram illustrating another example entropy encoding unit 56 that may be used in the video encoder 20 of FIG. 2. Entropy encoding unit 56 includes a scanning unit 74, a matrix encoding unit 76, a mapping unit 78 and a symbol encoding unit 80.

Scanning unit 74 is configured to scan a two-dimensional block of quantization matrix values (i.e., a quantization matrix) into a one-dimensional vector of quantization matrix values. The one-dimensional vector of quantization matrix values may be alternatively referred to herein as scanned quantization matrix values. In some examples, scanning unit 74 may scan the two-dimensional block of quantization matrix values based on a raster scan order. The raster scan order may generally refer to an order in which values in the quantization matrix are traversed in rows from top to bottom and within each row from left to right.

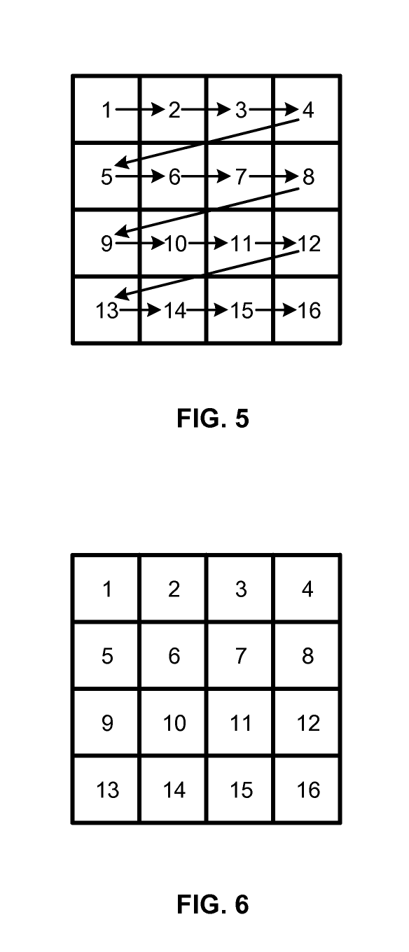

FIG. 5 is a conceptual diagram illustrating the order in which quantization matrix values are traversed when scanning the quantization matrix according to a raster scan order. The numbers in the matrix in FIG. 5 indicate scan positions in the quantization matrix, where each of the values in the quantization matrix is associated with a respective position in the matrix. As shown in FIG. 5, the raster scan order scans the position in the following order: {1, 2, 3, 4, 5, 6, 7, 8, 9, 10, 11, 12, 13, 14, 15, 16}.

Returning to FIG. 4, matrix encoding unit 76 is configured to encode quantization matrix values based on a predictor definition to generate a set of quantization matrix prediction residuals (i.e. prediction errors) for the quantization matrix. The predictor definition may be configured to generate prediction residuals for a quantization matrix that are skewed in favor of positive values. In some examples, the predictor definition may define a predictor for a value to be predicted in the quantization matrix based on a value in the quantization matrix that is immediately above the value to be predicted and a value in the quantization matrix that is immediately to the left of the value to be predicted. In such examples, matrix encoding unit 76 may encode a first value in a quantization matrix based on a predictor that is equal to a maximum of a second value and a third value in the quantization matrix. The second value may have a position in the quantization matrix that is immediately left of a position corresponding to the first value in the quantization matrix. The third value may have a position in the quantization matrix that is immediately above the position corresponding to the first value in the quantization matrix. If the left or top position is outside the matrix, it may be assigned a zero value or some other fixed value.

FIG. 6 is a conceptual diagram illustrating an example quantization matrix that may be encoded according to the techniques of this disclosure. The numbers in the matrix indicate scan positions within the quantization matrix. Each of the scan positions is associated with a respective one of a plurality of quantization matrix values. Each of the values in the quantization matrix may be used to determine at least one of an amount of quantization to be applied to a corresponding transform coefficient in a video block and an amount of inverse quantization to be applied to a corresponding quantized transform coefficient in a video block. For the quantization matrix value at scan position 11, the above-described predictor definition may define a predictor for encoding the value at scan position 11 to be equal to a maximum of the value at scan position 10 (i.e., the value having a position in the quantization matrix that is immediately to the left of a position corresponding to the value to be encoded in the quantization matrix) and the value at scan position 7 (i.e., the value having a position in the quantization matrix that is immediately above a position corresponding to the value to be encoded in the quantization matrix).

For quantization matrix values associated with scan positions along the top row of the quantization matrix, (i.e., scan positions {1, 2, 3, 4} in FIG. 6), the values that are immediately above these scan position may be set to zero (or some other fixed value) for purposes of defining the predictor. Similarly, for quantization matrix values associated with scan positions along the left column of the quantization matrix (i.e., scan positions {1, 5, 9, 13} in FIG. 6), the values that are immediately to the left of these scan position may be set to zero (or some other fixed value) for purposes of defining the predictor.

Mapping unit 78 is configured to convert (e.g., map) a set of source symbols that correspond to quantization matrix prediction residuals to a set of mapped symbols based on a mapping between symbol values in a source symbol alphabet and symbol values in a mapped symbol alphabet. Symbol encoding unit 80 is configured to encode the mapped symbols based on a variable length code to generate an encoded signal that includes the variable length code words. The variable length codewords may be representative of the quantization matrix prediction residuals. Mapping unit 78 and symbol encoding unit 80 are substantially similar to mapping unit 70 and symbol encoding unit 72, respectively, in FIG. 3 except that, instead of receiving general source symbols like mapping unit 70 in FIG. 3, mapping unit 78 receives source symbols that represent quantized matrix prediction residuals.

In previous standards such as MPEG-2 and AVC/H.264, quantization matrices, as described above, were used to improve subjective quality. For AVC/H.264, separate quantization matrices were used for Intra/Inter coding modes and also for Y, U and V components. For 4×4 blocks, there were 6 quantization matrices. For 8×8 blocks, only quantization matrices for the Y component were allowed. Thus, there were 2 possible quantization matrices for 8×8 blocks.

In the developing HEVC standard, transform sizes of 4×4, 8×8, 16×16, and 32×32 are possible. To extend the concept of quantization matrices to HEVC, in some examples 20 quantization matrices may be used (e.g., separate matrices for 4×4, 8×8, and 16×16, intra/inter, and Y, U, V components, and separate matrices for 32×32, intra/inter, and Y components). In such an example, 4064 values may need to be signaled. AVC/H.264 uses zigzag scanning of quantization matrix entries, followed by first order prediction and exponential Golomb coding (with parameter=0) to losslessly compress the quantization matrices. However, better compression methods are needed in HEVC due to the large number of quantization matrix coefficients.

Quantization matrices are typically designed to take advantage of the human visual system (HVS). The human visual system is typically less sensitive to quantization errors at higher frequencies. One reason for this is that the contrast sensitivity function (CSF) of the human visual system decreases with increasing frequency, both in horizontal and vertical directions. Hence, for well-designed quantization matrices, the matrix entries increase both in the row (left to right) and column (top to bottom) directions. In particular, as a block of transform coefficients extends from DC in the upper left (0, 0) corner to highest frequency coefficients toward the lower right (n, n) corner, the corresponding values in the quantization matrix generally, but not necessarily without exception, increase. In the AVC/H.264 method, however, the zig-zag scan tends to disrupt this ordering. Thus, when first order prediction is performed, the prediction error has both positive as well as negative values. Because of this, AVC/H.264 uses signed exponential Golomb codes for coding quantization matrices, which affects coding efficiency.

This disclosure describes a raster scan and a very simple non-linear predictor technique for coding prediction error for values of a quantization matrix. According to an example technique, the predictor is the maximum of the value to the left and the value above in the quantization matrix with respect to the current scan position in the quantization matrix. In other words, as the quantization matrix is scanned in raster order, a current value in the quantization matrix is predicted based on the maximum of the value to the left of the current value and the value above the current value. The raster order may generally refer to an order in which values in the quantization matrix are scanned in rows from top to bottom and within each row from left to right. In general, values in the quantization matrix will correspond to respective transform coefficients in a block of transform coefficients, where coefficients toward the upper left tend to be low frequency and coefficients approaching the lower right increase in frequency.

For a current value at coordinate position [x, y], the predictor would be the maximum of the value to the left at coordinate position [x−1, y] and the value above at coordinate position [x, y−1], assuming the upper left corner is [0, 0] and the lower right corner is [n, n] in an n by n matrix. The difference between the predicted value and the actual, current value can then be coded, e.g., using the techniques described in this disclosure, such as techniques that make use of a modified mapping of source symbols to remapped symbols, followed by selection of variable length codewords, such as Golomb, Golomb-Rice, or exponential Golomb codewords, for the remapped symbols.

When determining a predictor for coding a value in a quantization matrix, unavailable values that are outside of the quantization matrix may be assumed to be 0 (or some other fixed value). For the top row, the values above the top row may be assumed to be unavailable and set equal to zero (or some other fixed value). For the leftmost column, the values to the left of the leftmost column may be assumed to be unavailable and set equal to zero (or some other fixed value). In case the compression of the prediction error is lossy, reconstructed ‘left’ and ‘above’ values may be used for prediction. Because the quantization matrix values generally, but not necessarily without exception, increase in the horizontal and vertical directions, the prediction errors for the proposed predictor are generally non-negative. The quantization matrix prediction techniques of this disclosure may be also be used to improve the compression of asymmetric quantization matrices, a case in which coding schemes that use zig-zag scanning orders may not be very effective.

In some examples, the prediction error is encoded using Golomb codes. The Golomb code parameter can be included by the encoder in the bit-stream (using a fixed or variable-length code) or can be known to both the encoder and the decoder. It is possible to use other methods, such as exponential Golomb coding, to encode the prediction error. Due to the slightly spread-out nature of the prediction error, a Golomb code may be desirable in some examples. To be able to encode occasional negative values, a remapping method as described in this disclosure may be used. For example, a coding scheme with a modified mapping, e.g., as described in this disclosure with reference to Tables 2 and 3 and equation (1), may be used to encode the prediction error values for the quantization matrix. Relatively large values for offset and m may be used since the prediction error for the proposed method is rarely non-negative. The values of the parameters, offset and m, can be fixed and known both to the encoder and the decoder. It is also possible to encode these parameters using fixed or variable-length codes.

It should be realized that the quantization matrix compression techniques of this disclosure may be combined with some of the methods described in Minhua Zhou and Vivienne Sze, “Further study on compact representation of quantization matrices,” JCTVC-F085, Torino, Italy, July 2009. For example, if the quantization matrices have 45 and/or 135 degree symmetry as defined in JCTVC-F085, the quantization matrix compression techniques of this disclosure may be modified as follows. Assume that a lossy version of the quantization matrix is created, if necessary, so that it satisfies the requisite symmetries. Then, initially, all positions in the quantization matrix are marked as unavailable. When proceeding through the raster scan, when a prediction error for a particular position is coded, that position is marked as available. Then, quantization matrix values for all of the other positions implied by the symmetries are calculated and those positions are marked as available. When proceeding with the raster scan, if a position is marked as available, prediction and coding for that position is skipped. Similarly, if the downsampling method in JCTVC-F085 is used, the proposed method can be used to encode the downsampled matrix. The symmetry properties for the downsampled matrix can be exploited in a similar manner as described above.

In some examples, the predicted quantization matrix value is zero a significant percentage of the time. In such examples, using Golomb or Golomb-Rice codes may be inferior to using an exponential Golomb code with parameter 0. This is because the exponential Golomb code uses 1 bit to code a zero value, whereas Golomb or Golomb-Rice codes need at least 2 bits. Hence, in some examples, a flag may be used to specify the type of code used (e.g., either Golomb/Golomb-Rice or exponential Golomb) that is used to code the quantization matrix.

In this example, the following steps are followed to encode a quantization matrix. First, a flag is signaled in the encoded video bitstream which indicates to a decoder the type of code (e.g., either exponential Golomb or Golomb/Golomb-Rice) that is used. Then, the parameter (e.g., the scaling factor) and offset for the appropriate code is signaled in the bitstream using fixed or variable length codes. If only one value for the parameter and/or offset is possible, and is known to both the encoder and decoder, its coding can be skipped. For example, if, in case of exponential Golomb coding, parameter 0 is always used, it is not necessary to include this parameter in the bitstream. Similarly, the actual values of parameters and offsets can be coded or an index (e.g., an index into an array which stores all possible values for offsets and parameters) can be coded to indicate the combination offset and parameter values. In this case, an encoder and decoder may store the same combination values for parameters and offsets (e.g., in an array). As an example, if possible Golomb parameters are 2, 4, 8, and 16, an index in the range [0,3] may be signaled to indicate the Golomb parameter.

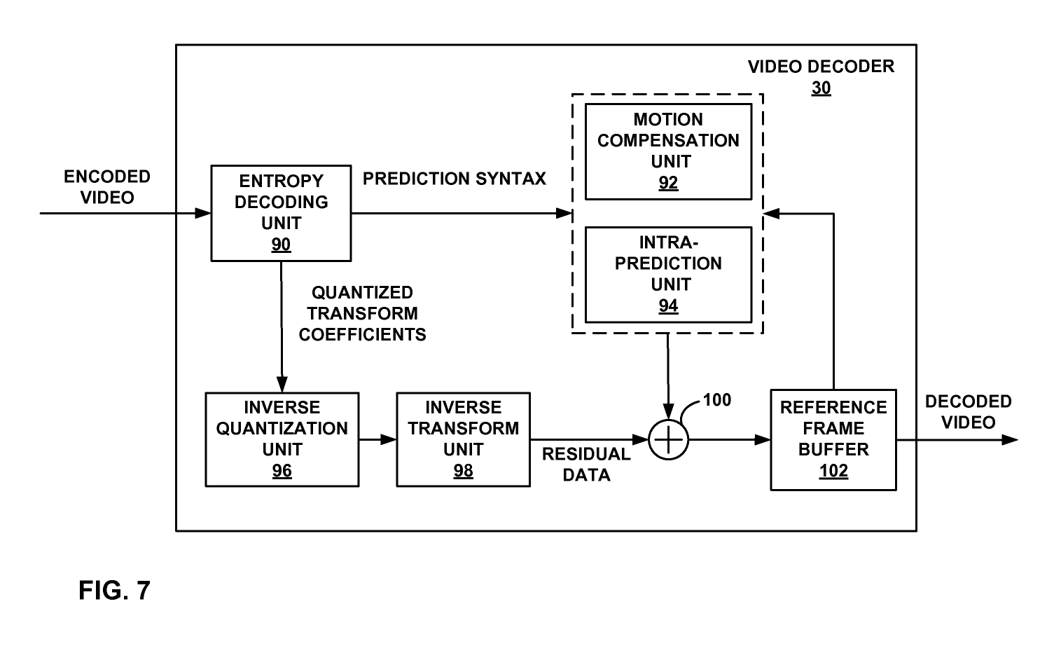

FIG. 7 is a block diagram illustrating an example of a video decoder 30 that may be configured to utilize techniques for coding non-symmetric distributions of video data and/or techniques for quantization matrix compression, as described in this disclosure. In the example of FIG. 7, video decoder 30 includes an entropy decoding unit 90, a motion compensation unit 92, an intra-prediction unit 94, an inverse quantization unit 96, an inverse transformation unit 78, a reference frame buffer 102 and a summer 100. Video decoder 30 may, in some examples, perform a decoding pass generally reciprocal to the encoding pass described with respect to video encoder 20 (see FIG. 2).

Entropy decoding unit 90 is configured to entropy decode a set of decoded symbols from an incoming bitstream. The incoming bitstream may include, for example, encoded quantized transform coefficients, encoded quantization matrix values, encoded quantization matrix prediction residuals, or any other type of encoded syntax elements, symbols, coefficients, or values that are used for coding video data. Entropy decoding in general may refer to the inverse of an entropy coding operation, for example, the lossless decoding or decompression of an incoming bitstream such that the original data is exactly reconstructed from the coded data. Entropy decoding unit 90 may perform entropy decoding based on a code that is designed to exploit statistical properties or dependencies within the original set of source symbols such that the coded data has a bitrate that is less than the bitrate of the original set of source symbols.

In some examples, entropy decoding unit 90 may decode a set of reconstructed symbols based on a variable length code. In such examples, the variable length code may map codewords of varying length in the incoming encoded bitstream to reconstructed symbols. In some cases, the variable length code may be configured to code a set of symbols such that relatively shorter codewords correspond to more likely symbols, while relatively longer codes correspond to less likely symbols.

According to some aspects of this disclosure, entropy decoding unit 90 may be configured to entropy decode mapped symbols from an encoded bitstream based on a variable length code to generate a set of reconstructed mapped symbols, and to convert (i.e., map) the set of reconstructed mapped symbols to a set of reconstructed source symbols based on a mapping between symbol values in a source symbol alphabet and symbol values in a mapped symbol alphabet. In general, the conversion operation performed by entropy decoding unit 90 may be the inverse of the conversion operation performed by entropy encoding unit 56 in FIG. 2. In some examples, the mapping used by entropy decoding unit 90 to perform the conversion operation may be the same mapping as that which is used by entropy encoding unit 56 in FIG. 2, but applied in a reverse direction. In additional examples, the mapping used by entropy decoding unit 90 to perform the conversion operation may be an inverse mapping that is the inverse of the mapping used by entropy encoding unit 56 in FIG. 2.

The mapping used by entropy decoding unit 90 may bias lower symbol values of the mapped symbol alphabet toward either positive symbol values or negative symbol values of the source symbol alphabet. The symbol values in the source symbol alphabet may include positive symbol values and negative symbol values. Each of the symbol values in the mapped symbol alphabet being a non-negative symbol value. In some examples, entropy decoding unit 90 may use a variable length code from the Golomb family, such as, e.g., a Golomb code, Golomb-Rice code, an exponential Golomb code, or a truncated version of such codes. The variable length code may assign relatively shorter codewords to relatively lower-valued symbols in the mapped symbol alphabet.

According to additional aspects of this disclosure, entropy decoding unit 90 may decode a quantization matrix from an encoded bitstream by using a predictor definition that is configured to, when used to encode the matrix, generate prediction residuals for the quantization matrix that are skewed in favor of positive values. Entropy decoding unit 90 may provide inverse quantization unit 96 with the decoded quantization matrix for use in inverse quantizing quantized transform coefficients. In some examples, entropy decoding unit 90 may decode a prediction residual corresponding to a first value in a quantization matrix based on a predictor that is equal to a maximum of a second value and a third value in the quantization matrix. The second value may have a position in the quantization matrix that is immediately left of a position corresponding to the first value in the quantization matrix. The third value may have a position in the quantization matrix that is immediately above the position corresponding to the first value in the quantization matrix.

Entropy decoding unit 90 may, in some examples, entropy decode mapped symbols that correspond to quantization matrix prediction residuals from an encoded bitstream based on a variable length code to generate a set of reconstructed mapped symbols. In such examples, entropy decoding unit 90 may map the set of reconstructed mapped symbols to a set of source symbols that correspond to quantization prediction residuals based on a mapping between source symbol values in a source symbol alphabet and mapped symbol values in a mapped symbol alphabet.

In further examples, entropy decoding unit 90 may inverse scan the reconstructed set of source symbols after performing one or both of the variable length decoding and the post-decode mapping. Inverse scanning may refer to the process of converting a one-dimensional vector of symbols into a two-dimensional block of symbols. In some examples, entropy decoding unit 90 may be configured to inverse scan the coefficient values of a one-dimensional vector of source symbols into a two-dimensional block of source symbols based on a raster scan order. Entropy decoding unit 90 may also be configured to inverse scan using other scan orders, such as, e.g., a zig-zag scan order or a field scan order. In some examples, entropy decoding unit 90 may be configured to select an inverse scan order based on scan order mode information included in the encoded bitstream.

According to further aspects of this disclosure, entropy decoding unit 90 may be configured to scan quantization matrix values in a raster scan order after decoding the prediction residuals into quantization matrix values. In some examples, in order to ensure that values for scan positions in a quantization matrix that are used to decode other scan positions in the quantization matrix have already been decoded prior to decoding the other scan positions in the quantization matrix that rely on the decoded values, the values in the quantization matrix may be decoded in a raster scan order. By also scanning the quantization matrix values in a raster scan order, in such examples, the decoding of the quantization prediction residuals may take place in the same order as the order in which the encoded quantization prediction residuals were scanned by video encoder 20, thereby reducing the complexity of video decoder 30. In addition, using a raster scan order for both the decoding and scanning of quantization matrix values may allow, in some examples, a pipelined implementation of the decoding and inverse scanning operations to be used for decoding the quantization matrix, thereby increasing the coding performance of the system. For example, once a quantization matrix prediction residual has been decoded in a first stage, the decoded value may be passed on to a second stage to be inverse scanned without necessarily needing to wait for other scan positions to be decoded.

In some examples, entropy decoding unit 90 (or inverse quantization unit 96) may scan the received values using a scan mirroring the scanning mode used by entropy encoding unit 56 (or quantization unit 54) of video encoder 20. Although the scanning of coefficients may be performed in inverse quantization unit 96, scanning will be described for purposes of illustration as being performed by entropy decoding unit 90. In addition, although shown as separate functional units for ease of illustration, the structure and functionality of entropy decoding unit 90, inverse quantization unit 96, and other units of video decoder 30 may be highly integrated with one another.

When the encoded bitstream contains quantized transform coefficients, entropy decoding unit 90 performs an entropy decoding process on the encoded bitstream to retrieve a one-dimensional array of quantized transform coefficients. The entropy decoding process used depends on the entropy coding used by video encoder 20 (e.g., CABAC, CAVLC, etc.). The entropy coding process used by the encoder may be signaled in the encoded bitstream or may be a predetermined process.

Entropy decoding unit 90 or another coding unit may be configured to use an inverse of the modified mapping described above, e.g., for quantization matrix values or other values, such as video data, using a modified mapping of source symbols. In particular, entropy decoding unit 90 may apply a process that is generally inverse to the modified mapping used by the encoder, e.g., mapping variable length code such as Golomb, Golomb-Rice, or exponential Golomb codes to remapped symbols Y, and mapping the remapped symbols Y to source symbols X with a mapping that is inverse to the mapping described with reference to FIGS. 2 and 3, which uses an offset and a scaling factor. Also, entropy decoding unit 90 may operate to perform quantization matrix decompression process generally inverse to the quantization matrix compression described above.

Inverse quantization unit 96 may inverse quantize the quantized transform coefficients received from entropy decoding unit 90 to produce a set of reconstructed transform coefficients. In some examples, inverse quantization unit 96 may inverse quantize the quantized transform coefficients based on one or both of a quantization matrix and a quantization parameter. In such examples, the quantization matrix and/or quantization parameter may be used to determine a degree of inverse quantization to be performed by inverse quantization unit 96 on the quantized transform coefficients. In additional examples, the quantization matrix used by inverse quantization unit 96 to perform inverse quantization may be the same as the quantization matrix used by quantization unit 54 of video encoder 20 in FIG. 2 to perform quantization. Similarly, the quantization parameter used by inverse quantization unit 96 to perform inverse quantization may be the same as the quantization parameter used by quantization unit 54 of video encoder 20 in FIG. 2 to perform quantization. To determine the quantization matrix and quantization parameter to use for inverse quantization, inverse quantization unit 96 may receive quantization matrix information and quantization parameter information from entropy decoding unit 90. For example, the quantization matrix information and quantization parameter information may take the form of one or more encoded syntax elements in the encoded bitstream, and entropy decoding unit 90 may decode the syntax elements and provide the quantization matrix information and quantization parameter information to inverse quantization unit 96.

Inverse quantization unit 96 inverse quantizes, i.e., de-quantizes, the quantized transform coefficients provided in the bitstream and decoded by entropy decoding unit 90. The inverse quantization process may include a process similar to one or more of the processes proposed for HEVC or defined by the H.264 decoding standard. For example, in order to quantize a transform coefficient, quantization unit 54 may scale the quantized transform coefficient by a corresponding value in the quantization matrix and by a pre-transform scaling value. Quantization unit 54 may then shift the scaled transform coefficient by an amount that is based on the quantization parameter. In some cases, the pre-transform scaling value may be selected based on the quantization parameter. Other quantization techniques may also be used. The inverse quantization process may include use of a quantization parameter QP calculated by video encoder 20 for the CU to determine a degree of quantization and, likewise, a degree of inverse quantization that should be applied. Inverse quantization unit 96 may inverse quantize the transform coefficients either before or after the coefficients are converted from a one-dimensional array to a two-dimensional array.

In some cases, inverse quantization unit 96 may perform a pre-transform scaling operation in addition the quantization operation. The pre-transform scaling operation may be used in conjunction with a core transform operation performed by inverse transform unit 98 to effectively perform a complete inverse frequency transform operation or an approximation thereof with respect to a block of quantized transform coefficients. In some examples, the pre-transform scaling operation may be integrated with the inverse quantization operation performed by inverse quantization unit 96 such that the pre-transform operation and the quantization operation are performed as part of the same set of operations with respect to a quantized transform coefficient to be inverse quantized.

Inverse transform unit 98 applies an inverse transform to the inverse quantized transform coefficients. In some examples, inverse transform unit 98 may determine an inverse transform based on signaling from video encoder 20, or by inferring the transform from one or more coding characteristics such as block size, coding mode, or the like. In some examples, inverse transform unit 98 may determine a transform to apply to the current block based on a signaled transform at the root node of a quadtree for an LCU including the current block. Alternatively, the transform may be signaled at the root of a TU quadtree for a leaf-node CU in the LCU quadtree. In some examples, inverse transform unit 98 may apply a cascaded inverse transform, in which inverse transform unit 98 applies two or more inverse transforms to the transform coefficients of the current block being decoded.

In some examples, the inverse transform performed by inverse transform unit 98 may be an inverse of the transform performed by transform unit 52 of video encoder 20 in FIG. 2. In examples where the space-to-frequency transform operation performed by the encoding stage of video encoder 20 may be subdivided into a core transform operation and a post-transform scaling operation, the inverse frequency transform may also be subdivided into a pre-transform scaling operation and a core transform operation. In such cases, inverse transform unit 98 may allow the pre-transform scaling operation to be performed by inverse quantization unit 96 in conjunction with the inverse quantization of the quantized transform coefficients, and perform the core transform operation on the pre-scaled reconstructed transform coefficients.

Intra-prediction unit 94 may generate prediction data for a current block of a current frame based on a signaled intra-prediction mode and data from previously decoded blocks of the current frame. Based on the retrieved motion prediction direction, reference frame index, and calculated current motion vector (e.g., a motion vector copied from a neighboring block according to a merge mode), the motion compensation unit produces a motion compensated block for the current portion. These motion compensated blocks essentially recreate the predictive block used to produce the residual data.

Motion compensation unit 92 may produce the motion compensated blocks, possibly performing interpolation based on interpolation filters. Identifiers for interpolation filters to be used for motion estimation with sub-pixel precision may be included in the syntax elements. Motion compensation unit 92 may use interpolation filters as used by video encoder 20 during encoding of the video block to calculate interpolated values for sub-integer pixels of a reference block. Motion compensation unit 92 may determine the interpolation filters used by video encoder 20 according to received syntax information and use the interpolation filters to produce predictive blocks.

Additionally, motion compensation unit 92 and intra-prediction unit 94, in an HEVC example, may use some of the syntax information (e.g., provided by a quadtree) to determine sizes of LCUs used to encode frame(s) of the encoded video sequence. Motion compensation unit 92 and intra-prediction unit 94 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

Summer 100 combines the residual blocks with the corresponding prediction blocks generated by motion compensation unit 92 or intra-prediction unit 94 to form decoded blocks. If desired, a deblocking filter may also be applied to filter the decoded blocks in order to remove blockiness artifacts. The decoded video blocks are then stored in the reference frame buffer 102, which provides reference blocks for subsequent motion compensation and also produces decoded video for presentation on a display device (such as display device 32 of FIG. 1).

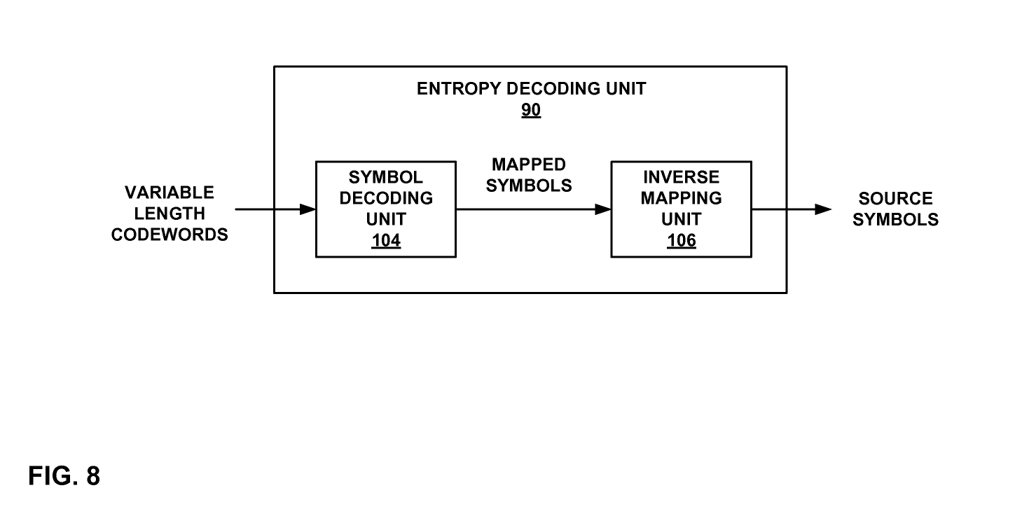

FIG. 8 is a block diagram illustrating an example entropy decoding unit 90 that may be used in the video decoder 30 of FIG. 7. Entropy decoding unit 90 includes a symbol decoding unit 104 and an inverse mapping unit 106. Symbol decoding unit 104 is configured to decode mapped symbols from a stream of variable length code words based on a variable length code to generate a decoded set of mapped symbols. Inverse mapping unit 106 is configured to convert (e.g., map) the decoded set of mapped symbols to a decoded set of source symbols based on a mapping between symbol values in a source symbol alphabet and symbol values in a mapped symbol alphabet.

In some examples, the mapping used by inverse mapping unit 106 to perform the conversion operation may be substantially similar to the mapping used by mapping unit 70 in FIG. 3. In further examples, the mapping used by inverse mapping unit 106 to perform the conversion operation may be substantially similar to an inverse of the mapping used by mapping unit 70 in FIG. 3.

In some examples, inverse mapping unit 106 may be configured to selectively apply one of a plurality of different mappings to a decoded set of mapped symbols. For example, inverse mapping unit 106 may select a mapping to apply to a decoded set of mapped symbols based on information indicative of a type of syntax element to be decoded, information indicative of a prediction mode associated with the set of symbols to be decoded, and/or information indicative of a mapping mode to be used for decoding the mapped symbols. In some cases, the information used to select the mapping mode may be included in the received bitstream. In further examples, inverse mapping unit 106 may be selectively disabled such that no mapping of decoded mapped symbols to source symbols occurs after symbol decoding unit 104 performs variable length decoding. In other words, in such examples, the decoded mapped symbols may form the decoded source symbols.

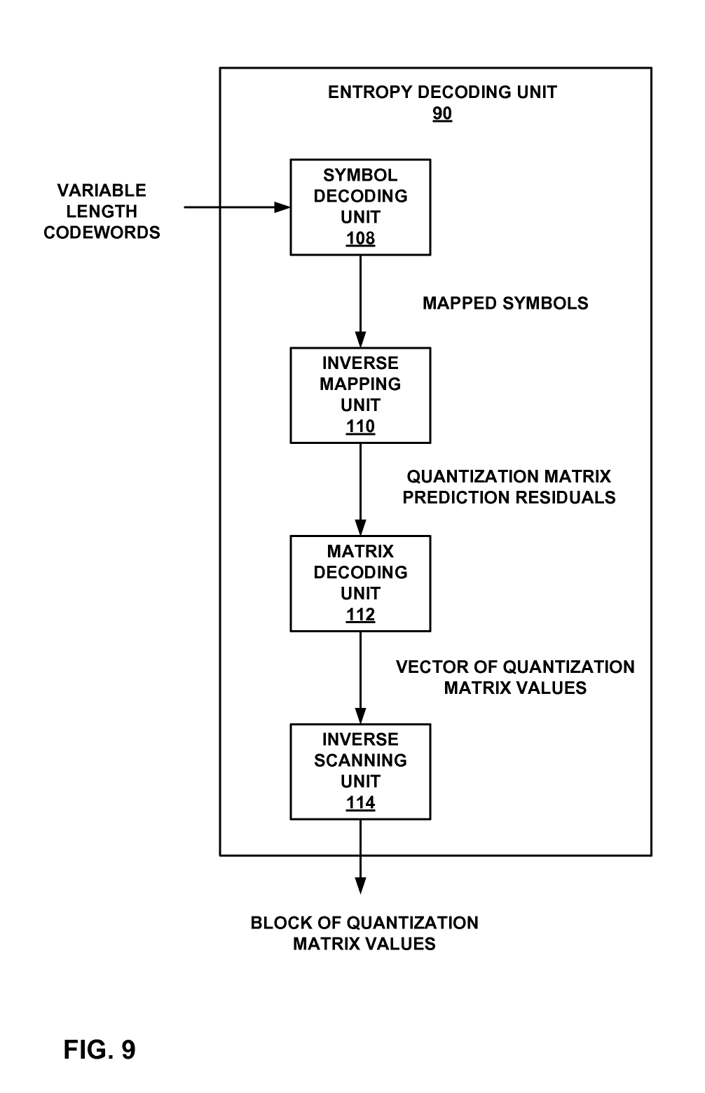

FIG. 9 is a block diagram illustrating another example entropy decoding unit 90 that may be used in the video decoder 30 of FIG. 7. Entropy decoding unit 90 includes a symbol decoding unit 108, an inverse mapping unit 110, a matrix decoding unit 112 and an inverse scanning unit 114.

Symbol decoding unit 108 is configured to decode mapped symbols from a stream of variable length code words based on a variable length code to generate a decoded set of mapped symbols. Inverse mapping unit 110 is configured to convert (e.g., map) the decoded set of mapped symbols to a decoded set of source symbols based on a mapping between symbol values in a source symbol alphabet and symbol values in a mapped symbol alphabet. The decoded set of symbols may include symbols that are representative of a plurality of quantization matrix prediction residuals. Symbol decoding unit 108 and inverse mapping unit 110 are substantially similar, respectively, to symbol decoding unit 104 and inverse mapping unit 106 in FIG. 8 except that, instead of producing general source symbols like inverse mapping unit 106 in FIG. 8, inverse mapping unit 110 produces source symbols that represent quantized matrix prediction residuals.

Matrix decoding unit 112 is configured to decode quantization matrix values from the quantization matrix prediction residuals based on a predictor definition and based on previously decoded quantization matrix values. The predictor definition may be configured to, when used to encode the quantization matrix, generate prediction residuals for a quantization matrix that are skewed in favor of positive values. For example, the predictor definition may define a predictor for a value to be coded based on a value in the quantization matrix that is immediately above the value to be predicted and a value in the quantization matrix that is immediately to the left of the value to be predicted. In such examples, matrix decoding unit 112 may decode a first value in a quantization matrix based on a predictor that is equal to a maximum of a second value and a third value in the quantization matrix. The second value may have a position in the quantization matrix that is immediately left of a position corresponding to the first value in the quantization matrix. The third value may have a position in the quantization matrix that is immediately above the position corresponding to the first value in the quantization matrix.

Inverse scanning unit 114 is configured to inverse scan a one-dimensional vector of quantization matrix values into a two-dimensional block of quantization matrix values (i.e., a quantization matrix). The one-dimensional block of quantization matrix values may be alternatively referred to as scanned quantization matrix values. In some examples, inverse scanning unit 114 may inverse scan the two-dimensional block of quantization matrix values based on a raster scan order. Inverse scanning unit 114 outputs the decoded quantization matrix values to an inverse quantization unit (e.g., inverse quantization unit 96 in FIG. 7).

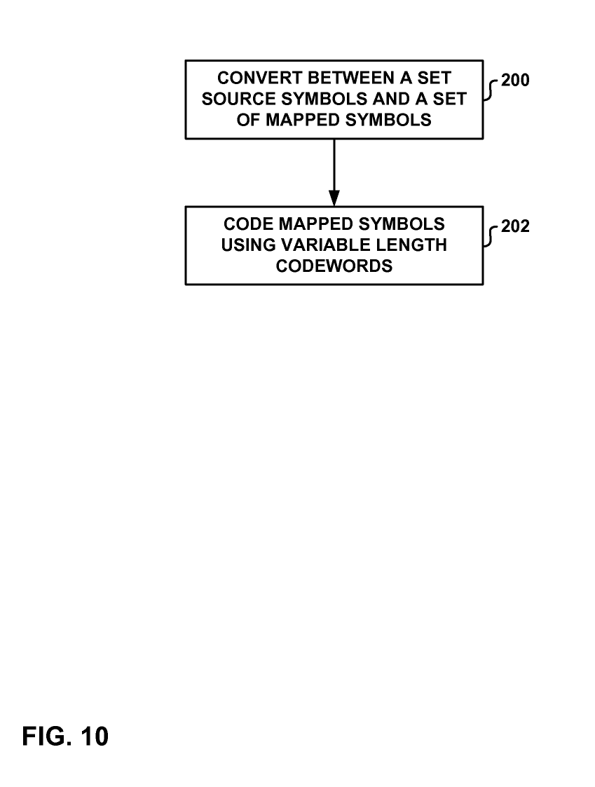

FIG. 10 is a flow diagram illustrating an example technique for coding non-symmetric distributions of data according to this disclosure. Video encoder 20 and/or video decoder 30 converts (e.g., maps) between a set of source symbols selected from a source symbol alphabet and a set of mapped symbols selected from a mapped symbol alphabet based on a mapping between symbol values in a source symbol alphabet and symbol values in a mapped symbol alphabet (200). In some examples, the set of source symbols may be representative of video data. In further examples, the set of source symbols may be representative of data and/or parameters that are used to code video data, such as, e.g., quantization matrix values. The symbol values in the source symbol alphabet may include positive symbol values and negative symbol values. Each of the symbol values in the mapped symbol alphabet may be a non-negative symbol value. Video encoder 20 and/or video decoder 30 codes the mapped symbols using variable length codewords (202).

In some examples, the mapping may bias lower symbol values of the mapped symbol alphabet toward positive symbol values of the source symbol alphabet. For example, the mapping may assign more positive symbol values in the source symbol alphabet than non-positive symbol values in the source symbol alphabet to L lowest-valued symbol values in the mapped symbol alphabet for at least one L where L is an integer greater than or equal to two. As another example, for a set of K lowest-valued symbol values in the mapped symbol alphabet, the number of positive source symbols that are assigned by the mapping to the set of K lowest-valued symbol values in the mapped symbol alphabet may be greater than K/2 for at least one K where K is an integer greater than or equal to two.

In further examples, the mapping may bias lower symbol values of the mapped symbol alphabet toward negative symbol values of the source symbol alphabet. For example, the mapping may assign more negative symbol values in the source symbol alphabet than non-negative symbol values in the source symbol alphabet to L lowest-valued symbol values in the mapped symbol alphabet for at least one L where L is an integer greater than or equal to two. As another example, for a set of K lowest-valued symbol values in the mapped symbol alphabet, the number of negative source symbols that are assigned by the mapping to the set of K lowest-valued symbol values in the mapped symbol alphabet may be greater than K/2 for at least one K where K is an integer greater than or equal to two. Other mappings are also possible as described in other portions of this disclosure.

The variable length codewords may be defined by a variable length code, and video encoder 20 and/or video decoder 30 may code the mapped symbols based on the variable length code. In some examples, the variable length code may be a variable length code from the Golomb family of codes, such as, e.g., one of a Golomb code, a Golomb-Rice code or an exponential-Golomb code.

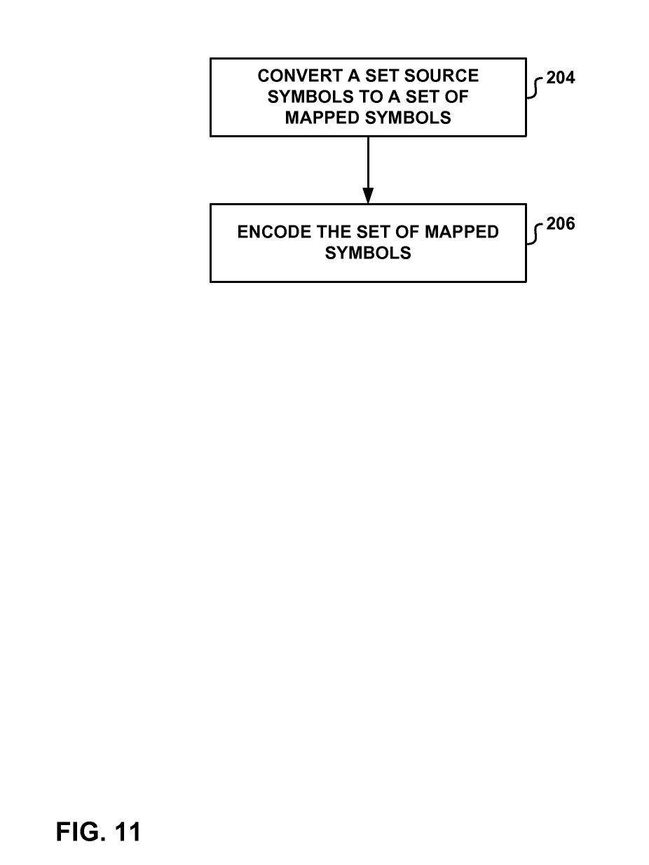

FIG. 11 is a flow diagram illustrating an example technique for encoding non-symmetric distributions of data according to this disclosure. Video encoder 20 converts (e.g., maps) a set of source symbols to a set of mapped symbols based on a mapping between symbol values in a source symbol alphabet and symbol values in a mapped symbol alphabet (204). Video encoder 20 encodes the set of the mapped symbols based on a variable length code to generate an encoded bitstream that includes the variable length code words (206). The mapping may be substantially similar to one or more of the mappings described above with respect to FIG. 10.

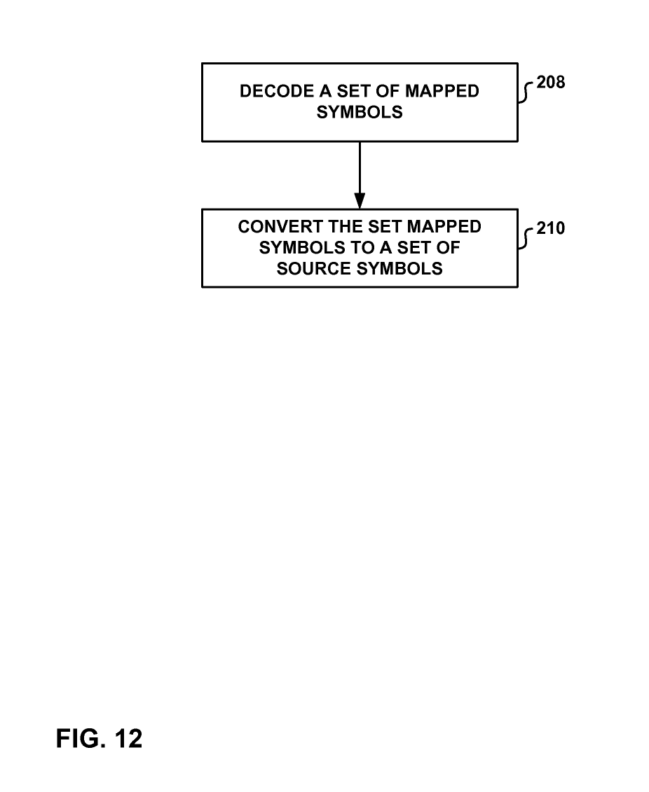

FIG. 12 is a flow diagram illustrating an example technique for decoding non-symmetric distributions of data according to this disclosure. Video decoder 30 decodes a set of mapped symbols from an encoded bistream that includes variable length codewords based on a variable length code (208). Video decoder 30 converts (e.g., maps) the set of mapped symbols to a set of source symbols based on a mapping between symbol values in a source symbol alphabet and symbol values in a mapped symbol alphabet (210). The mapping may be substantially similar to one or more of the mappings described above with respect to FIG. 10 and/or substantially similar to an inverse of one or more of the mappings described above with respect to FIG. 10.

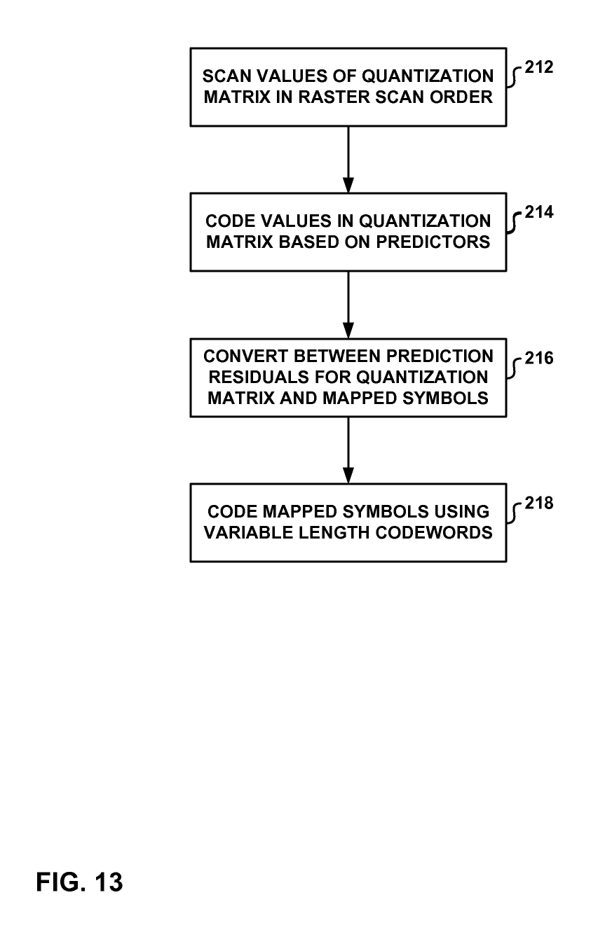

FIG. 13 is a flow diagram illustrating an example technique for coding a quantization matrix according to this disclosure. Video encoder 20 and/or video decoder 30 scans values of a quantization matrix in a raster scan order (212). Video encoder 20 and/or video decoder 30 codes values in the quantization matrix based on one or more predictors (214). Each of the values in the quantization matrix may be used to determine at least one of an amount of quantization to be applied to a corresponding transform coefficient in a video block and an amount of inverse quantization to be applied to a corresponding quantized transform coefficient in a video block. The predictor for coding each of a plurality of values in the quantization matrix may be equal to the maximum of a value immediately to the left of the scan position of the value to be coded in the quantization matrix and a value immediately above the scan position of the value to be coded in the quantization matrix. Other types of predictors are also possible.

In some examples, the values of the quantization matrix may be coded in a raster scan order. In further examples, the values of the quantization matrix may be coded in a same order as the order in which the values are scanned.

In some examples, video encoder 20 and/or video decoder 30 may code a first value in the quantization matrix based on a predictor that is equal to a maximum of a second value and a third value in the quantization matrix. The second value may have a position in the quantization matrix that is immediately left of a position corresponding to the first value in the quantization matrix. The third value may have a position in the quantization matrix that is immediately above the position corresponding to the first value in the quantization matrix. A prediction error (e.g., difference) between the first value and the predictor may correspond to a prediction residual for the quantization matrix.

In additional examples, video encoder 20 and/or video decoder 30 may code each of a plurality of values in the quantization matrix based on a predictor definition that defines a predictor for each of the values to be coded in the quantization matrix as being equal to a maximum of a first value and a second value of the quantization matrix. The first value may have a position in the quantization matrix that is immediately left of a position corresponding to the respective value to be coded in the quantization matrix. The second value may have a position in the quantization matrix that is immediately above the position corresponding to the respective prediction residual to be coded in the quantization matrix. The coded values in the quantization matrix may correspond to a plurality of prediction residuals for the quantization matrix, and each of the prediction residuals may correspond to a prediction error (e.g., a difference) between a respective one of the values to be coded and a predictor corresponding to the respective one of the values to be coded.

Video encoder 20 and/or video decoder 30 converts (e.g., maps) between prediction residuals for a quantization matrix (i.e., a set of source symbols) and a set of mapped symbols based on a mapping between symbol values in a source symbol alphabet and symbol values in a mapped symbol alphabet (216). Video encoder 20 and/or video decoder 30 codes the mapped symbols using variable length codewords (218). The source symbols are representative of prediction residuals for a plurality of values in a quantization matrix. The mapping may be substantially similar to one or more of the mappings described above with respect to FIG. 10. For example, the mapping may be a mapping that biases lower symbol values of the mapped symbol alphabet toward positive symbol values of the source symbol alphabet.

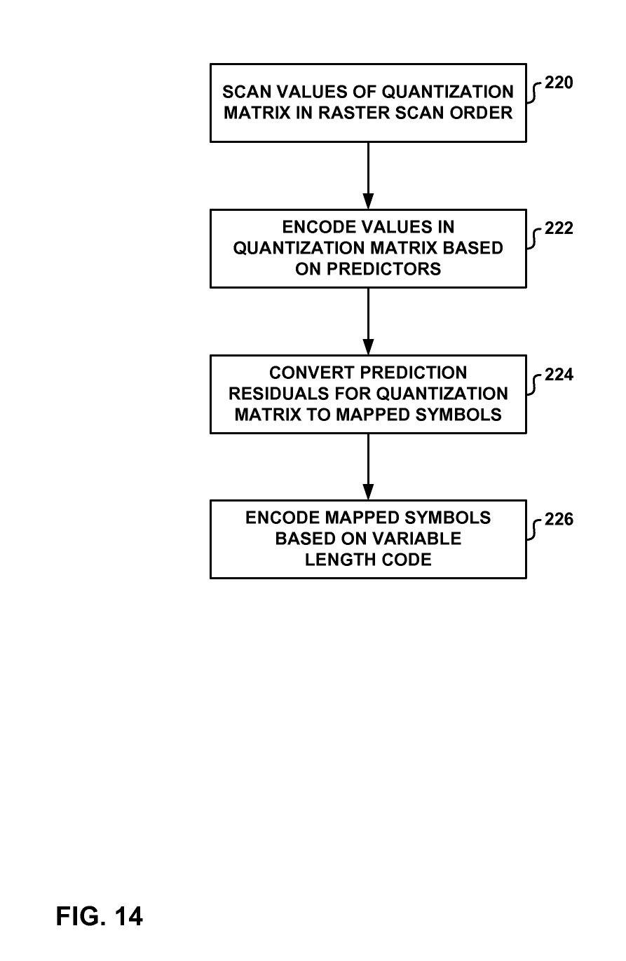

FIG. 14 is a flow diagram illustrating an example technique for encoding a quantization matrix according to this disclosure. Video encoder 20 scans values of a quantization matrix in a raster scan order (220). For example, video encoder 20 may convert a two-dimensional representation of quantization matrix values into a one-dimensional representation of quantization matrix values (i.e., a set of scanned quantization matrix values). Video encoder 20 encodes the values in the quantization matrix based on one or more predictors (222). The predictor for encoding each of a plurality of values in the quantization matrix may be equal to the maximum of a value immediately to the left of the scan position of the value to be coded in the quantization matrix and a value immediately above the scan position of the value to be coded in the quantization matrix.

In some examples, the values of the quantization matrix may be encoded in a raster scan order. In further examples, the values of the quantization matrix may be encoded in a same order as the order in which the values are scanned.

Video encoder 20 converts (e.g., maps) the prediction residuals for the quantization matrix (i.e., a set of source symbols) to a set of mapped symbols based on a mapping between symbol values in a source symbol alphabet and symbol values in a mapped symbol alphabet (224). Video encoder 20 codes the mapped symbols using variable length codewords (226). The source symbols are representative of prediction residuals for a plurality of values in a quantization matrix. The mapping may be substantially similar to the mapping described above with respect to FIG. 10.

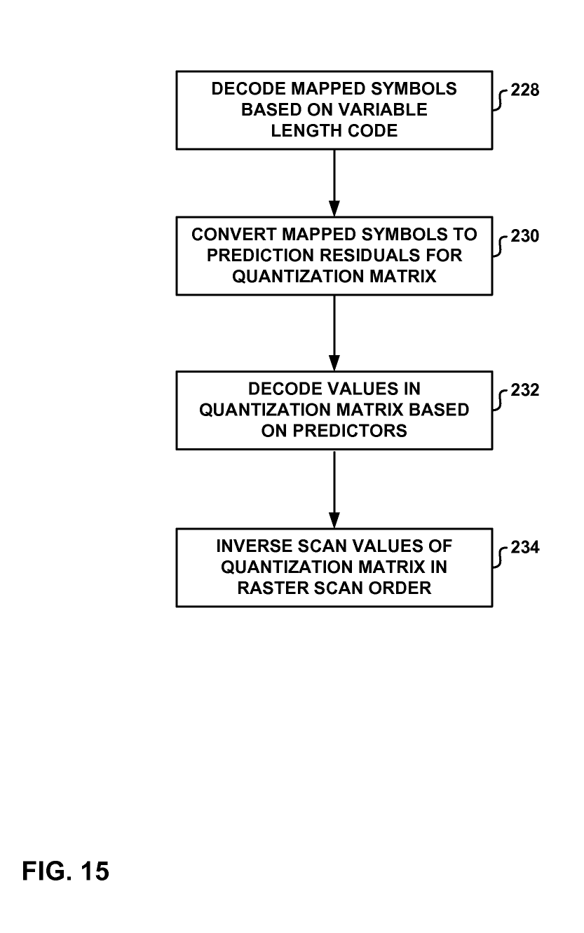

FIG. 15 is a flow diagram illustrating an example technique for decoding a quantization matrix according to this disclosure. Video decoder 30 decodes a set of mapped symbols from an encoded bistream that includes variable length codewords based on a variable length code (228). Video decoder 30 converts (e.g., maps) the set of mapped symbols to a set of source symbols based on a mapping between symbol values in a source symbol alphabet and symbol values in a mapped symbol alphabet (230). The source symbols are representative of prediction residuals for a plurality of values in a quantization matrix. The mapping may be substantially similar to one or more of the mappings described above with respect to FIG. 10 and/or to an inverse of one or more of the mappings described above with respect to FIG. 10. For example, the mapping may be a mapping that biases lower symbol values of the mapped symbol alphabet toward positive symbol values of the source symbol alphabet or an inverse of such a mapping.

Video decoder 30 decodes a plurality of values in the quantization matrix based on one or more predictors (232). The predictor for decoding each of a plurality of values in the quantization matrix may be equal to the maximum of a decoded value immediately to the left of the scan position of the value to be coded in the quantization matrix and a decoded value immediately above the scan position of the value to be coded in the quantization matrix. Video decoder 30 inverse scans the values in the quantization matrix in a raster scan order (234). For example, video decoder 30 converts a one-dimensional representation of quantization matrix values (i.e., a set of scanned quantization matrix values) into a two-dimensional representation of quantization matrix values (i.e., a quantization matrix).

In some examples, the values of the quantization matrix may be decoded in a raster scan order. In further examples, the values of the quantization matrix may be decoded in a same order as the order in which the values are scanned by video encoder 20 and/or inverse scanned by video decoder 30.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for coding video data comprising:
converting between a set of source symbols selected from a source symbol alphabet and a set of mapped symbols selected from a mapped symbol alphabet based on a mapping between symbol values in the source symbol alphabet and symbol values in the mapped symbol alphabet, the symbol values in the source symbol alphabet including positive symbol values and negative symbol values, each of the symbol values in the mapped symbol alphabet being a non-negative symbol value, wherein the mapping biases lower symbol values of the mapped symbol alphabet toward positive symbol values of the source symbol alphabet or negative symbol values of the source symbol alphabet; and
coding the mapped symbols using variable length codewords.

2. The method of claim 1, wherein the mapping biases lower symbol values of the mapped symbol alphabet toward positive symbol values of the source symbol alphabet.

3. The method of claim 2, wherein the mapping assigns more positive symbol values in the source symbol alphabet than non-positive symbol values in the source symbol alphabet to L lowest-valued symbol values in the mapped symbol alphabet for at least one L, where L is an integer greater than or equal to two.

4. The method of claim 2, wherein the mapping assigns positive symbol values in the source symbol alphabet to at least two consecutive symbol values in the mapped symbol alphabet.

5. The method of claim 2, wherein the mapping assigns a respective one of a plurality of non-negative symbol values in the source symbol alphabet to each of N lowest-valued symbol values in the mapped symbol alphabet, where N is an integer greater than or equal to two.

6. The method of claim 2, wherein for at least a subset of the symbol values in the mapped symbol alphabet, the mapping assigns a respective one of the negative symbol values in the source symbol alphabet to every Mth symbol value in the subset of the symbol values, and assigns respective ones of the positive symbol values in the source symbol alphabet to (M−1) symbol values in the mapped symbol alphabet that are between every Mth symbol value in the subset of the symbol values, where M is an integer greater than or equal to three.

7. The method of claim 2, wherein converting between the set of source symbols selected from the source symbol alphabet and the set of mapped symbols selected from the mapped symbol alphabet comprises:
converting between the set of source symbols and the set of mapped symbols based on an offset that specifies a number of lowest-valued symbols in the mapped symbol alphabet that are assigned to non-negative symbol values in the source symbol alphabet, the number of lowest-valued symbols being greater than or equal to three lowest-valued symbols.

8. The method of claim 2, wherein converting between the set of source symbols selected from the source symbol alphabet and the set of mapped symbols selected from the mapped symbol alphabet comprises:
converting between the set of source symbols and the set of mapped symbols based on a scaling factor that specifies a distance between symbol values in the mapped symbol alphabet that are assigned to negative symbol values in the source symbol alphabet, the distance being greater than or equal to three symbol values.

9. The method of claim 2, wherein the mapping assigns symbol values in the mapped symbol alphabet to symbol values in the source symbol alphabet according to the following formulas:
For X<0 Y=offset+(−X−1)*m
For 0≦X<offset Y=X
For X≧offset Y=X+└(X−offset)/(m−1)┘+1
where X is a symbol value in the source symbol alphabet, Y is a symbol value in the mapped symbol alphabet, the operator └x┘ means the largest integer that is less than or equal to x, offset is an integer greater than zero, and m is an integer greater than or equal to two.

10. The method of claim 9, wherein the offset is equal to 4 and m is equal to 3.

11. The method of claim 1, wherein the variable length codewords include codewords defined according to one of a Golomb code, a Golomb-Rice code and an exponential-Golomb code.

12. The method of claim 1, wherein the video data is a quantization matrix and the source symbols are representative of prediction residuals for a plurality of values in the quantization matrix.

13. The method of claim 12, wherein each of the prediction residuals corresponds to a respective one of the values in the quantization matrix, each of the values being used to determine at least one of an amount of quantization to be applied to a corresponding transform coefficient in a video block and an amount of inverse quantization to be applied to a corresponding quantized transform coefficient in a video block.

14. The method of claim 12, further comprising:
coding a first value in the quantization matrix based on a predictor that is equal to a maximum of a second value and a third value in the quantization matrix, the second value having a position in the quantization matrix that is left of a position corresponding to the first value in the quantization matrix, the third value having a position in the quantization matrix that is above the position corresponding to the first value in the quantization matrix,
wherein at least one of the prediction residuals corresponds to a prediction error between the first value and the predictor.

15. The method of claim 14, further comprising:
scanning the values in the quantization matrix in a raster scan order.

16. The method of claim 1,
wherein coding the video data comprises encoding the video data,
wherein converting between the set of source symbols selected from the source symbol alphabet and the set of mapped symbols selected from the mapped symbol alphabet comprises converting the set of source symbols to the set of mapped symbols based on the mapping, and
wherein coding the mapped symbols using the variable length code words comprises encoding the mapped symbols based on a variable length code to generate an encoded signal that includes the variable length code words.

17. The method of claim 1,
wherein coding the video data comprises decoding the video data,
wherein converting between the set of source symbols selected from the source symbol alphabet and the set of mapped symbols selected from the mapped symbol alphabet comprises converting the set of mapped symbols to the set of source symbols based on the mapping, and
wherein coding the mapped symbols using the variable length codewords comprises decoding the mapped symbols from an encoded signal that includes the variable length codewords based on a variable length code.

18. A device for coding video data comprising:
one or more processors configured to convert between a set of source symbols selected from a source symbol alphabet and a set of mapped symbols selected from a mapped symbol alphabet based on a mapping between symbol values in the source symbol alphabet and symbol values in the mapped symbol alphabet, and to code the mapped symbols using variable length codewords, the symbol values in the source symbol alphabet including positive symbol values and negative symbol values, each of the symbol values in the mapped symbol alphabet being a non-negative symbol value, wherein the mapping biases lower symbol values of the mapped symbol alphabet toward positive symbol values of the source symbol alphabet or negative symbol values of the source symbol alphabet.

19. The device of claim 18, wherein the mapping biases lower symbol values of the mapped symbol alphabet toward positive symbol values of the source symbol alphabet.

20. The device of claim 19, wherein the mapping assigns more positive symbol values in the source symbol alphabet than non-positive symbol values in the source symbol alphabet to L lowest-valued symbol values in the mapped symbol alphabet for at least one L, where L is an integer greater than or equal to two.

21. The device of claim 19, wherein the mapping assigns positive symbol values in the source symbol alphabet to at least two consecutive symbol values in the mapped symbol alphabet.

22. The device of claim 19, wherein the mapping assigns a respective one of a plurality of non-negative symbol values in the source symbol alphabet to each of N lowest-valued symbol values in the mapped symbol alphabet, where N is an integer greater than or equal to two.

23. The device of claim 19, wherein for at least a subset of the symbol values in the mapped symbol alphabet, the mapping assigns a respective one of the negative symbol values in the source symbol alphabet to every Mth symbol value in the subset of the symbol values, and assigns respective ones of the positive symbol values in the source symbol alphabet to (M−1) symbol values in the mapped symbol alphabet that are between every Mth symbol value in the subset of the symbol values, where M is an integer greater than or equal to three.

24. The device of claim 19, wherein the one or more processors are further configured to convert between the set of source symbols and the set of mapped symbols based on an offset that specifies a number of lowest-valued symbols in the mapped symbol alphabet that are assigned to non-negative symbol values in the source symbol alphabet, the number of lowest-valued symbols being greater than or equal to three lowest-valued symbols.

25. The device of claim 19, wherein the one or more processors are further configured to convert between the set of source symbols and the set of mapped symbols based on a scaling factor that specifies a distance between symbol values in the mapped symbol alphabet that are assigned to negative symbol values in the source symbol alphabet, the distance being greater than or equal to three symbol values.

26. The device of claim 19, wherein the mapping assigns symbol values in the mapped symbol alphabet to symbol values in the source symbol alphabet according to the following formulas:
For X<0 Y=offset+(−X−1)*m
For 0≦X<offset Y=X
For X≧offset Y=X+└(X−offset)/(m−1)┘+1
where X is a symbol value in the source symbol alphabet, Y is a symbol value in the mapped symbol alphabet, the operator └x┘ means the largest integer that is less than or equal to x, offset is an integer greater than zero, and m is an integer greater than or equal to two.

27. The device of claim 26, wherein the offset is equal to 4 and m is equal to 3.

28. The device of claim 18, wherein the variable length codewords include codewords defined according to one of a Golomb code, a Golomb-Rice code and an exponential-Golomb code.

29. The device of claim 18, wherein the source symbols are representative of prediction residuals for a plurality of values in a quantization matrix.

30. The device of claim 29, wherein each of the prediction residuals corresponds to a respective one of the values in the quantization matrix, each of the values being used to determine at least one of an amount of quantization to be applied to a corresponding transform coefficient in a video block and an amount of inverse quantization to be applied to a corresponding quantized transform coefficient in a video block.

31. The device of claim 29, wherein the one or more processors are further configured to code a first value in the quantization matrix based on a predictor that is equal to a maximum of a second value and a third value in the quantization matrix, the second value having a position in the quantization matrix that is left of a position corresponding to the first value in the quantization matrix, the third value having a position in the quantization matrix that is above the position corresponding to the first value in the quantization matrix, wherein at least one of the prediction residuals corresponds to a prediction error between the first value and the predictor.

32. The device of claim 31, wherein the one or more processors are further configured to scan the values in the quantization matrix in a raster scan order.

33. The device of claim 18, wherein coding the video data comprises encoding the video data, and wherein the one or more processors are further configured to convert the set of source symbols to a set of mapped symbols based on the mapping, and encode the mapped symbols based on a variable length code to generate an encoded signal that includes the variable length code words.

34. The device of claim 18, wherein coding the video data comprises decoding the video data, and wherein the one or more processors are further configured to convert the set of mapped symbols to the set of source symbols based on the mapping, and decode the mapped symbols from an encoded signal that includes the variable length codewords based on a variable length code.

35. The device of claim 18, wherein the device comprises one or more of a wireless communication device and a mobile phone handset.

36. An apparatus for coding video data comprising:
means for converting between a set of source symbols selected from a source symbol alphabet and a set of mapped symbols selected from a mapped symbol alphabet based on a mapping between symbol values in the source symbol alphabet and symbol values in the mapped symbol alphabet, the symbol values in the source symbol alphabet including positive symbol values and negative symbol values, each of the symbol values in the mapped symbol alphabet being a non-negative symbol value, wherein the mapping biases lower symbol values of the mapped symbol alphabet toward positive symbol values of the source symbol alphabet or negative symbol values of the source symbol alphabet; and
means for coding the mapped symbols using variable length codewords.

37. A computer-readable storage medium storing instructions that, when executed, cause one or more processors to:
convert between a set of source symbols selected from a source symbol alphabet and a set of mapped symbols selected from a mapped symbol alphabet based on a mapping between symbol values in the source symbol alphabet and symbol values in the mapped symbol alphabet, the symbol values in the source symbol alphabet including positive symbol values and negative symbol values, each of the symbol values in the mapped symbol alphabet being a non-negative symbol value, wherein the mapping biases lower symbol values of the mapped symbol alphabet toward positive symbol values of the source symbol alphabet or negative symbol values of the source symbol alphabet; and
code the mapped symbols using variable length codewords.

38. The computer-readable storage medium of claim 37, wherein the mapping biases lower symbol values of the mapped symbol alphabet toward positive symbol values of the source symbol alphabet.

39. The computer-readable storage medium of claim 38, wherein the mapping assigns more positive symbol values in the source symbol alphabet than non-positive symbol values in the source symbol alphabet to L lowest-valued symbol values in the mapped symbol alphabet for at least one L where L is selected from the set of integers greater than or equal to two.

40. The computer-readable storage medium of claim 38, wherein the mapping assigns symbol values in the mapped symbol value alphabet to symbol values in the source symbol alphabet according to the following formulas:
For X<0 Y=offset+(−X−1)*m
For 0≦X<offset Y=X
For X≧offset Y=X+└(X−offset)/(m−1)┘+1
where X is a symbol value in the source symbol alphabet, Y is a symbol value in the mapped symbol alphabet, the operator └x┘ means the largest integer that is less than or equal to x, offset is an integer greater than zero, and m is an integer greater than or equal to two.
